(19) United States
(12) Patent Application Publication
(10) Pub. No.: US 2022/0314512 A1
(43) Pub. Date: Oct. 6, 2022

(54) INJECTION MOLDING MACHINE, ADDITIVE MANUFACTURING APPARATUS, AND ABNORMALITY DETECTION METHOD

(71) Applicant: TOYOTA JIDOSHA KABUSHIKI KAISHA, Toyota-shi (JP)

(72) Inventor: Yasuhiro YAMAMOTO, Toyota-shi (JP)

(73) Assignee: TOYOTA JIDOSHA KABUSHIKI KAISHA, Toyota-shi (JP)

(21) Appl. No.: 17/655,254

(22) Filed: Mar. 17, 2022

(30) Foreign Application Priority Data
Mar. 30, 2021 (JP) 2021-058209

(51) Int. Cl. B29C 45/77; B29C 64/386; B33Y 30/00; B33Y 50/00

(52) U.S. Cl. CPC B29C 45/77; B29C 64/386; B33Y 30/00; B33Y 50/00; B29C 2945/76006

(57) ABSTRACT

An injection molding machine includes a cylinder housing molten resin, a discharge nozzle communicating with the cylinder, and a piston that slides inside the cylinder and pressurizes the molten resin inside the cylinder to discharge the molten resin through the discharge nozzle. The injection molding machine includes a target pressure acquisition part that acquires a target pressure that is a target value in pressurizing the molten resin inside the cylinder, a measured pressure detection part that detects a measured pressure of the molten resin inside the cylinder, and an abnormality detection part that detects an abnormality based on the target pressure and the measured pressure.

### CROSS-REFERENCE TO RELATED APPLICATION

This application claims priority to Japanese Patent Application No. 2021-058209 filed on Mar. 30, 2021, incorporated herein by reference in its entirety.

### BACKGROUND

### 1. Technical Field

The present disclosure relates to an injection molding machine, an additive manufacturing apparatus, and an abnormality detection method.

### 2. Description of Related Art

A molding apparatus including a resin discharge nozzle (such as a 3D printer) is required to correctly control the discharge flow rate. For example, in Japanese Patent No. 5920859, an amount discharged through a nozzle is controlled by controlling a pressure on resin inside a cylinder.

### SUMMARY

However, when the pressure on the resin inside the cylinder is controlled to achieve a target pressure, the discharge nozzle (discharge hole) may become clogged with unmelted resin fragments or discharged resin may contain air. As a result, the actual pressure on the resin fails to meet the target pressure, which may consequently lead to equipment failure and molding failure.

Having been contrived to solve this problem, the present disclosure provides an injection molding machine, an additive manufacturing apparatus, and an abnormality detection method that can detect occurrence of abnormalities, including the discharge nozzle (discharge hole) becoming clogged with unmelted resin fragments and the discharged resin containing air.

An injection molding machine according to the present disclosure is an injection molding machine including a cylinder housing molten resin, a discharge nozzle communicating with the cylinder, and a piston that slides inside the cylinder and pressurizes the molten resin inside the cylinder to discharge the molten resin through the discharge nozzle. This injection molding machine includes a target pressure acquisition part that acquires a target pressure that is a target value in pressurizing the molten resin inside the cylinder, a measured pressure detection part that detects a measured pressure of the molten resin inside the cylinder, and an abnormality detection part that detects an abnormality based on the target pressure and the measured pressure.

This configuration makes it possible to detect abnormalities, including the discharge nozzle (discharge hole) becoming clogged with unmelted resin fragments and the discharged resin containing air.

This is because the injection molding machine includes the abnormality detection part that detects an abnormality based on the target pressure and the measured pressure.

The abnormality detection part may detect the abnormality when a difference between the target pressure and the measured pressure meets a predetermined criterion.

The abnormality detection part may detect the abnormality when the difference exceeds a threshold value.

The abnormality detection part may detect the abnormality when the number of times that the difference has exceeded the threshold value exceeds a predetermined number of times.

The injection molding machine may further include an abnormality notification part that notifies of the abnormality when the abnormality detection part has detected the abnormality.

Thus, occurrence of an abnormality can be easily recognized.

An additive manufacturing apparatus according to the present disclosure is an additive manufacturing apparatus that includes the injection molding machine according to any one of the above-mentioned disclosures and creates a three-dimensional shaped article by layering the molten resin discharged through the discharge nozzle.

The additive manufacturing apparatus may further include a position storage part that, when the abnormality detection part has detected the abnormality, stores a coordinate of the discharge nozzle at the point in time when the abnormality has been detected.

When an abnormality occurs, an additively manufactured object (three-dimensional shaped article) may have an abnormality such as a defect. By thus storing the coordinate, whether the abnormality (defect position) is at an allowable level can be easily determined in an inspection of the additionally manufactured object (three-dimensional shaped article) upon completion.

When a difference between the target pressure and the measured pressure meets a predetermined first criterion, the abnormality detection part may detect a first abnormality and stop the discharge nozzle.

When a difference between the target pressure and the measured pressure meets a predetermined second criterion, the abnormality detection part may detect a second abnormality and store, in the position storage part, a coordinate of the discharge nozzle at the point in time when the second abnormality has been detected.

This makes it possible, for example, when the difference is large, to stop the equipment, which would otherwise break down, and when the difference is of a certain magnitude, to continue molding and later inspect the article for defect.

An abnormality that the abnormality detection part detects when the target pressure is higher than the measured pressure and an abnormality that the abnormality detection part detects when the target pressure is lower than the measured pressure may be different from each other.

Thus, the cause of an abnormality, for example, whether it is intrusion of air or clogging due to resin fragments, can be identified.

An abnormality detection method according to the present disclosure is a method of detecting an abnormality in an injection molding machine including, a cylinder housing molten resin, a discharge nozzle communicating with the cylinder, and a piston that slides inside the cylinder and pressurizes the molten resin inside the cylinder to discharge the molten resin through the discharge nozzle. This method includes a target pressure acquisition step of acquiring a target pressure that is a target value in pressurizing the molten resin inside the cylinder, a measured pressure detection step of detecting a measured pressure of the molten resin inside the cylinder, and an abnormality detection step of detecting an abnormality based on the target pressure and the measured pressure.

The present disclosure can provide an injection molding machine, an additive manufacturing apparatus, and an abnormality detection method that can detect occurrence of abnormalities, including the discharge nozzle (discharge hole) becoming clogged with unmelted resin fragments and the discharged resin containing air.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view schematically showing an injection molding apparatus of Embodiment 1;

FIG. 2 is a block diagram of a control system of the injection molding apparatus of Embodiment 1;

FIG. 3 is an enlarged view of part of an injection molding machine of Embodiment 1 on a Z-axis minus side;

FIG. 4 is a view of section IV-IV of FIG. 3 as seen from the arrow direction;

FIG. 5 is a view of section V-V of FIG. 1 as seen from the arrow direction;

FIG. 6 is a view of section VI-VI of FIG. 3 as seen from the arrow direction;

FIG. 7 is a perspective view showing a first piston unit and a second piston unit of Embodiment 1;

FIG. 8 is an exploded view showing the first piston unit and the second piston unit of Embodiment 1;

FIG. 9 is a view showing the operation of the injection molding apparatus of Embodiment 1;

FIG. 10 is a view showing the operation of the injection molding apparatus of Embodiment 1;

FIG. 11 is a view showing the operation of the injection molding apparatus of Embodiment 1;

FIG. 12 is a view showing the operation of the injection molding apparatus of Embodiment 1;

FIG. 13 is a view showing the operation of the injection molding apparatus of Embodiment 1;

FIG. 14 is a configuration view of an injection molding machine 2A of Embodiment 2;

FIG. 15 is a configuration diagram of a control device 7A of Embodiment 2;

FIG. 16A is a graph showing a relationship between nozzle moving speed and specified flow rate (a case where a nozzle diameter is 1 mm and a cylinder diameter is 20 mm);

FIG. 16B is another graph showing a relationship between the nozzle moving speed and the specified flow rate (a case where the nozzle diameter is 12 mm and the cylinder diameter is 100 mm);

FIG. 17 is examples (representative examples) of exponents;

FIG. 18A is one example of a table of calculated numerical values of a bulk modulus;

FIG. 18B is a graph on which values of FIG. 18A are plotted;

FIG. 19 is a specific example of conversion of a relationship between pressure and flow rate into a relationship between shear velocity and melt viscosity (name of resin: ABS, temperature: 210° C.);

FIG. 20 is a graph on which the shear velocity and the melt viscosity of FIG. 19 are plotted;

FIG. 21 is a flowchart of an example of the operation of a target pressure calculation part 31A;

FIG. 22 is a flowchart of an example of the operation of a moving speed calculation part 32A (torpedo moving speed feedforward control);

FIG. 23 is a schematic view showing elements of Expression 10;

FIG. 24 is a schematic view showing elements of Expression 12 to Expression 15;

FIG. 25 is a flowchart of an example of the operation of second and subsequent cycles of discharge;

FIG. 26 is a schematic view showing elements of Expression 18 and Expression 19;

FIG. 27 is a flowchart common to Example 1 and Example 2 of flow rate control;

FIG. 28 is a table summarizing simulation results (first to third cycles) of Example 1;

FIG. 29 is a table summarizing simulation results (first to third cycles) of Example 2;

FIG. 30 is a configuration diagram of a control device 7B of Embodiment 3;

FIG. 31 is a flowchart of an example of the operation of an abnormality detection part 35A (logic for determining automatic stop and defect occurrence);

FIG. 32 is a flowchart of another example of the operation of the abnormality detection part 35A (logic for determining automatic stop and defect occurrence);

FIG. 33 is a flowchart of an example of a method of recording an estimated position of creation defect as applied to a 3D printer;

FIG. 34 is a table summarizing results (first to sixth cycles) of Example 3;

FIG. 35 is examples of estimated positions of creation defects stored in a position storage part 25 (nozzle positions at points in time when the abnormality detection part 35A has detected abnormalities (defects)); and

FIG. 36 is a table summarizing results (first to fifth cycles) of Example 4.

### DETAILED DESCRIPTION OF EMBODIMENTS

Specific embodiments to which this disclosure is applied will be described below in detail with reference to the drawings. However, this disclosure is not limited to the following embodiments. To clarify the description, the following texts and the drawings are simplified where appropriate.

### Embodiment 1

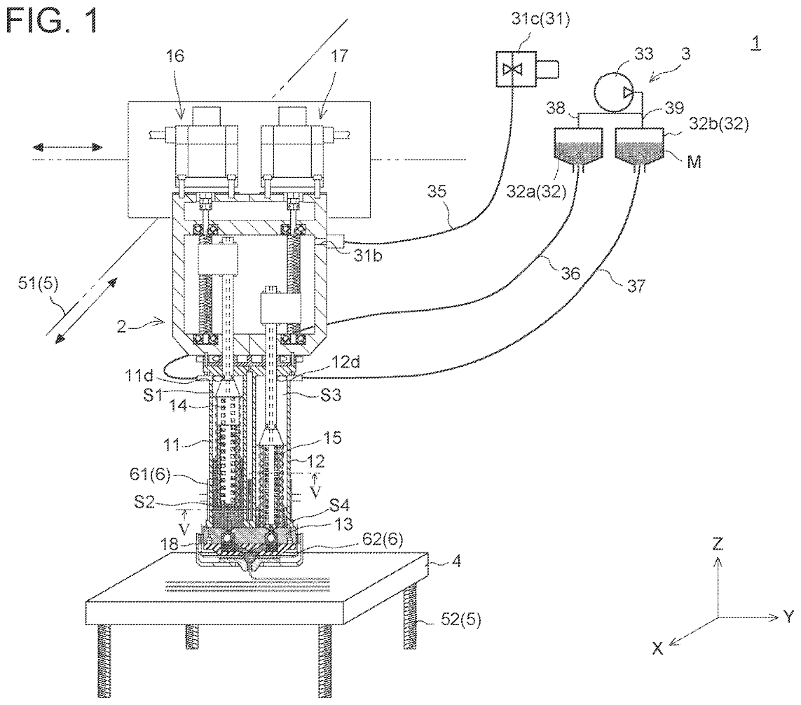

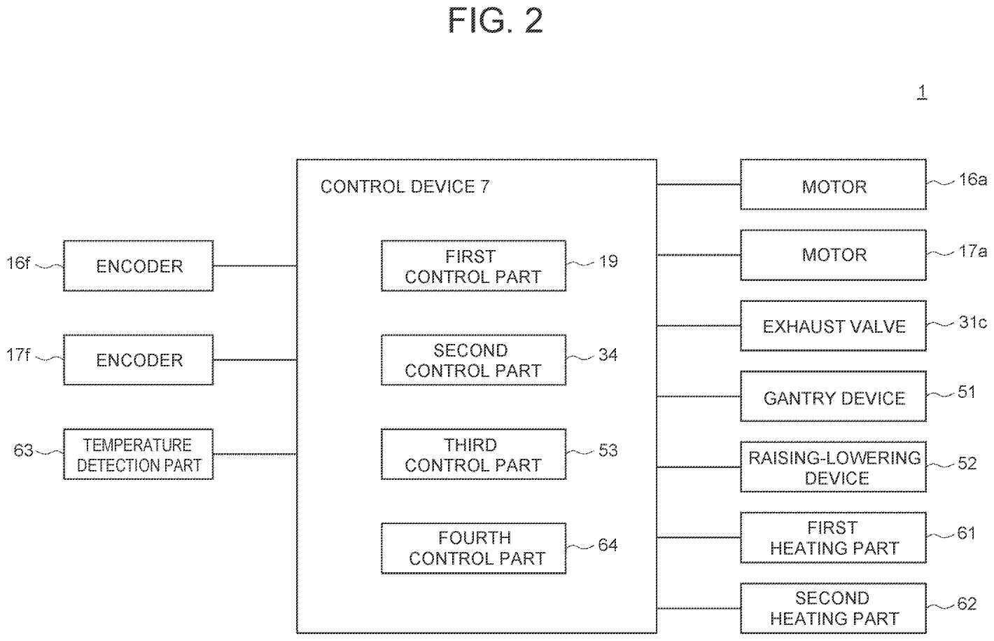

First, the configuration of an injection molding apparatus of an embodiment will be described. The injection molding apparatus of the embodiment is suitable for additive manufacturing of workpieces using an injection molding machine. FIG. 1 is a view schematically showing the injection molding apparatus of the embodiment. FIG. 2 is a block diagram of a control system of the injection molding apparatus of the embodiment. To clarify the description, a three-dimensional (XYZ) coordinate system will be used in the following description.

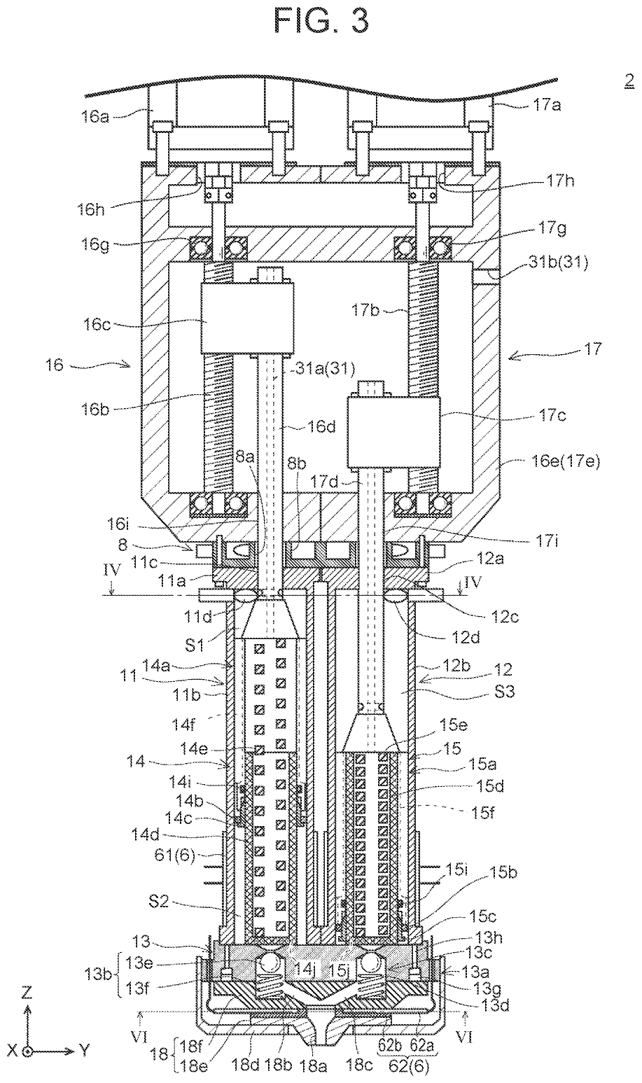

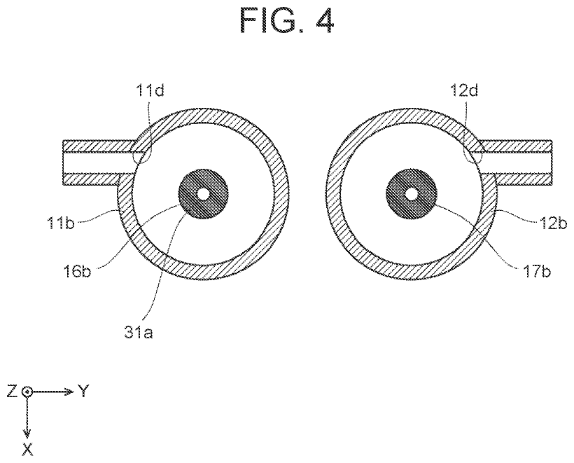

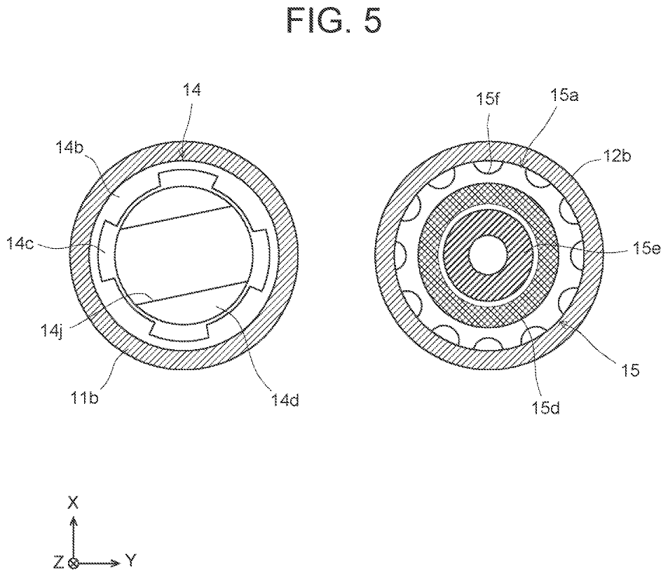

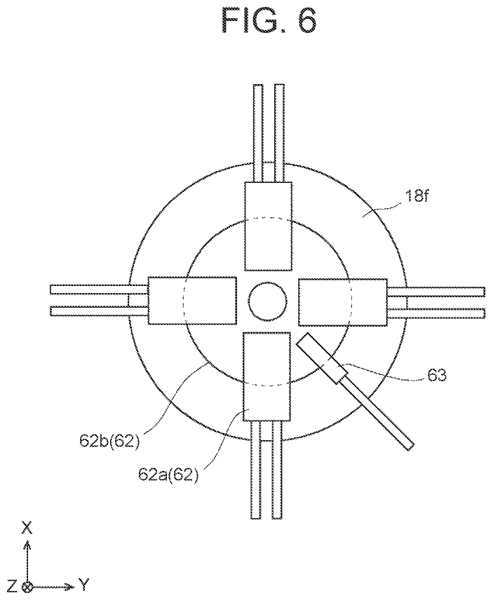

As shown in FIG. 1 and FIG. 2, the injection molding apparatus 1 includes an injection molding machine 2, a supply device 3, a table 4 (hereinafter also referred to as a baseplate 4), a moving device 5, a heating device 6, and a control device 7. The injection molding machine 2 is configured, for example, so as to be able to continuously inject molten resin. FIG. 3 is an enlarged view of part of the injection molding machine of the embodiment on a Z-axis minus side. FIG. 4 is a view of section IV-IV of FIG. 3 as seen from the arrow direction. FIG. 5 is a view of section V-V of FIG. 1 as seen from the arrow direction. FIG. 6 is a view of section VI-VI of FIG. 3 as seen from the arrow direction.

As shown in FIG. 1 to FIG. 3, the injection molding machine 2 includes a first cylinder 11, a second cylinder 12, an end plate 13, a first piston unit 14, a second piston unit 15, a first drive part 16, a second drive part 17, an injection part 18, and a first control part 19.

As shown in FIG. 3, the first cylinder 11 extends in a Z-axis direction, and is closed at an end on a Z-axis plus side to have a closed-topped cylindrical shape as a basic form. Specifically, the first cylinder 11 includes a closing part 11a disposed on the Z-axis plus side and a cylindrical side wall 11b that is continuous with a circumferential edge of the closing part 11a and extends from the closing part 11a toward the Z-axis minus side, and the first cylinder 11 is open at an end on the Z-axis minus side.

As shown in FIG. 3, a through-hole 11c that extends through the closing part 11a of the first cylinder 11 in the Z-axis direction is formed in the closing part 11a. Further, as shown in FIG. 3 and FIG. 4, a supply hole 11d through which a resin material is supplied is formed at a part of the side wall 11b of the first cylinder 11 on the Z-axis plus side. The resin material is, for example, resin pellets.

As shown in FIG. 3 and FIG. 4, the second cylinder 12 extends in the Z-axis direction and is disposed next to the first cylinder 11 in a Y-axis direction. The second cylinder 12 has the same configuration as the first cylinder 11 and therefore overlapping description thereof will be omitted. The second cylinder 12 includes a closing part 12a having a through-hole 12c and a side wall 12b having a supply hole 12d, and the second cylinder 12 is open at an end on the Z-axis minus side.

As shown in FIG. 3, the end plate 13 is fixed at ends of the first cylinder 11 and the second cylinder 12 on the Z-axis minus side. The end plate 13 includes a main body 13a and non-return valves 13b. The main body 13a has, for example, a plate shape as a basic form, and has through-holes 13c formed apart from each other in the Y-axis direction.

As shown in FIG. 3, the through-holes 13c extend through the main body 13a in the Z-axis direction, and a housing part 13d in which the non-return valve 13b is housed is provided at a part of each through-hole 13c on the Z-axis minus side. A surface of the housing part 13d on the Z-axis plus side is a sloping surface that slopes toward the Z-axis minus side while spreading from the center of the through-hole 13c toward an outer side.

In this case, a part of the through-hole 13c on the Z-axis plus side may include a sloping surface that slopes toward the Z-axis plus side while spreading from the center of the through-hole 13c toward the outer side, and an end of the sloping surface on the Z-axis minus side may be continuous with an end of the housing part 13d on the Z-axis plus side.

Each non-return valve 13b allows the molten resin to flow toward the Z-axis minus side and blocks the molten resin from flowing toward the Z-axis plus side. The non-return valve 13b can be formed by, for example, a check valve, and includes a check ball 13e and a spring 13f as shown in FIG. 3. Here, the elastic force of the spring 13f can be set as appropriate such that the non-return valve 13b opens when a preset pressure acts on the check ball 13e.

As shown in FIG. 3, the end plate 13 thus configured is fixed at the ends of the first cylinder 11 and the second cylinder 12 on the Z-axis minus side with bolts 13h that are passed through bolt holes 13g formed in the main body 13a, such that the opening of the first cylinder 11 on the Z-axis minus side and the opening of the second cylinder 12 on the Z-axis minus side are covered by the end plate 13.

In this case, the through-hole 13c of the end plate 13 on a Y-axis minus side is disposed on the Z-axis minus side relatively to the first cylinder 11, and the through-hole 13c of the end plate 13 on a Y-axis plus side is disposed on the Z-axis minus side relatively to the second cylinder 12.

Here, these through-holes 13c may be disposed such that a central axis of the through-hole 13c of the end plate 13 on the Y-axis minus side and a central axis of the first cylinder 11 substantially coincide with each other, and that a central axis of the through-hole 13c of the end plate 13 on the Y-axis plus side and a central axis of the second cylinder 12 substantially coincide with each other.

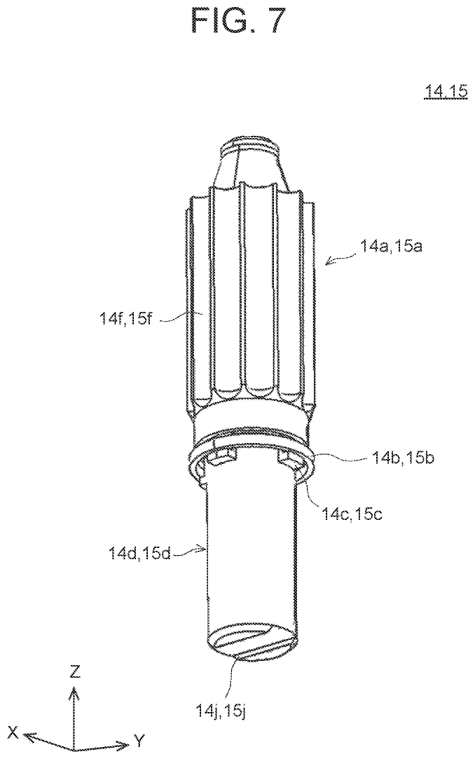

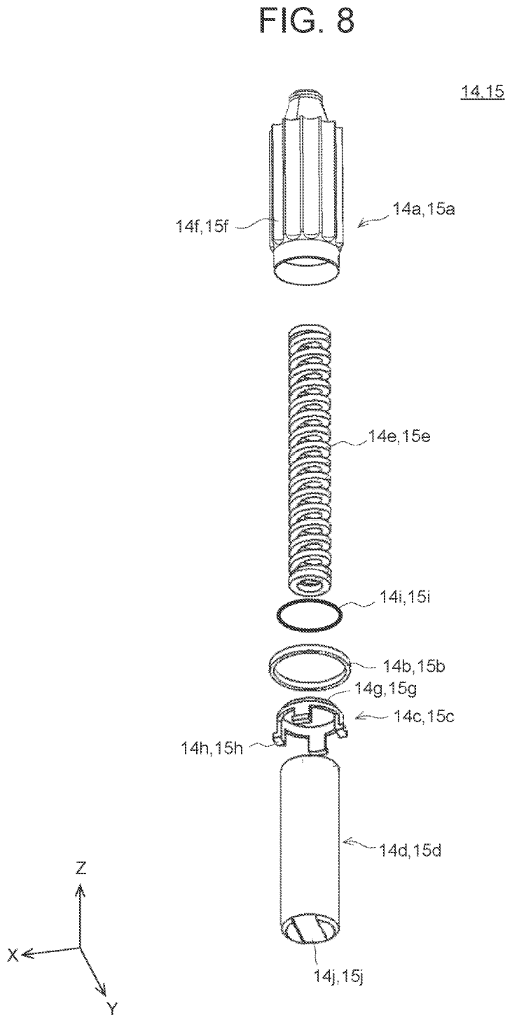

As shown in FIG. 3, the first piston unit 14 is disposed inside the first cylinder 11 so as to be slidable inside the first cylinder 11. FIG. 7 is a perspective view showing the first piston unit and the second piston unit of the embodiment. FIG. 8 is an exploded view showing the first piston unit and the second piston unit of the embodiment.

As shown in FIG. 7 and FIG. 8, the first piston unit 14 includes a torpedo piston 14a, a non-return ring 14b, a stopper 14c, a pressure piston 14d, and urging means 14e. The torpedo piston 14a is closed at an end on the Z-axis plus side to have a closed-topped cylindrical shape as a basic form, and has an outer circumferential shape that roughly corresponds to an inner circumferential shape of the first cylinder 11. In this case, a surface of the torpedo piston 14a on the Z-axis plus side may be a sloping surface that slopes toward the Z-axis minus side while spreading from the center of the torpedo piston 14a toward a circumferential edge thereof.

As shown in FIG. 7 and FIG. 8, grooves 14f are formed in an outer circumferential surface of the torpedo piston 14a. The grooves 14f extend in the Z-axis direction and are disposed at substantially regular intervals in a circumferential direction of the torpedo piston 14a.

As will be described later, the grooves 14f should be shaped and disposed such that, when the resin material supplied to a first space S1 of the first cylinder 11 located on the Z-axis plus side relatively to the first piston unit 14 passes through the grooves 14f, the resin material can be plasticized into molten resin and that this molten resin can flow into a second space S2 of the first cylinder 11 located on the Z-axis minus side relatively to the first piston unit 14.

As shown in FIG. 5, FIG. 7, and FIG. 8, the non-return ring 14b has an annular shape with an outer circumference having substantially the same shape as an inner circumference of the first cylinder 11, and is disposed on the Z-axis minus side relatively to the torpedo piston 14a. The stopper 14c holds the non-return ring 14b at an end of the torpedo piston 14a on the Z-axis minus side.

As shown in FIG. 8, the stopper 14c includes, for example, a ring part 14g and hook parts 14h. An outer circumference of the ring part 14g has substantially the same shape as an inner circumference of the torpedo piston 14a. Each hook part 14h has substantially an L-shape as seen from a direction orthogonal to the Z-axis, and an end of a vertical portion of the hook part 14h on the Z-axis plus side is fixed on the ring part 14g.

As shown in FIG. 8, a horizontal portion of each hook part 14h protrudes from an end of the vertical portion of the hook part 14h on the Z-axis minus side toward an outer side of the ring part 14g. The hook parts 14h are disposed at substantially regular intervals in a circumferential direction of the ring part 14g.

The ring part 14g is fitted in an opening at the end of the torpedo piston 14a on the Z-axis minus side, with the ring part 14g and the vertical portions of the hook parts 14h passed through a through-hole of the non-return ring 14b. Thus, the non-return ring 14b is held at the end of the torpedo piston 14a on the Z-axis minus side through the stopper 14c.

In this case, the length of the vertical portion of the hook part 14h in the Z-axis direction is greater than the thickness of the non-return ring 14b in the Z-axis direction. Therefore, the non-return ring 14b is movable in the Z-axis direction between the end of the first cylinder 11 on the Z-axis minus side and the horizontal portions of the hook parts 14h. At a minimum, the stopper 14c should be configured to be able to hold the non-return ring 14b at the end of the first cylinder 11 on the Z-axis minus side so as to be movable in the Z-axis direction.

As shown in FIG. 7 and FIG. 8, the pressure piston 14d is closed at an end on the Z-axis minus side to have a closed-bottomed cylindrical shape, and an end surface of the pressure piston 14d on the Z-axis minus side is, for example, a substantially flat surface parallel to an XY-plane. An outer circumference of the pressure piston 14d has substantially the same shape as the inner circumference of the torpedo piston 14a.

As shown in FIG. 3, the pressure piston 14d is slidably inserted inside the torpedo piston 14a in a state where a gap between an inner circumferential surface of the torpedo piston 14a and an outer circumferential surface of the pressure piston 14d is closed by a seal member 14i.

Thus, the inside of the torpedo piston 14a functions as a sliding part of the pressure piston 14d, and as the pressure piston 14d slides relatively to the torpedo piston 14a in the Z-axis direction, the amount of protrusion thereof into the second space S2 of the first cylinder 11 relative to the torpedo piston 14a changes. The area of a region surrounded by an outer circumferential edge of the pressure piston 14d, a maximum amount of movement thereof, and other specifications will be described later.

As shown in FIG. 7 and FIG. 8, an entry part 14j for the molten resin to enter, of which detailed functions will be described later, may be formed in the end surface of the pressure piston 14d on the Z-axis minus side. The entry part 14j is, for example, a groove formed in the end surface of the pressure piston 14d on the Z-axis minus side and extends in a direction orthogonal to the Z-axis.

At a minimum, the entry part 14j should be shaped to allow the molten resin to enter a gap between the end surface of the pressure piston 14d on the Z-axis minus side and the end of the end plate 13 on the Z-axis plus side in a state where the end surface of the pressure piston 14d on the Z-axis minus side is in contact with the end of the end plate 13 on the Z-axis plus side.

The urging means 14e urges the pressure piston 14d toward the second space S2 of the first cylinder 11 relatively to the torpedo piston 14a. For example, the urging means 14e is an elastic member, such as a coil spring, as shown in FIG. 8.

The urging means 14e is disposed inside the pressure piston 14d in a state where an end of the urging means 14e on the Z-axis plus side is in contact with the end of the torpedo piston 14a on the Z-axis plus side and an end of the urging means 14e on the Z-axis minus side is in contact with the end of the pressure piston 14d on the Z-axis minus side. The urging force of the urging means 14e and other specifications will be described later.

As shown in FIG. 3, the second piston unit 15 is disposed inside the second cylinder 12 so as to be slidable inside the second cylinder 12. The second piston unit 15 has the same configuration as the first piston unit 14 and therefore overlapping description thereof will be omitted. As shown in FIG. 5, FIG. 7, and FIG. 8, the second piston unit 15 includes a torpedo piston 15a with grooves 15f formed in an outer circumferential surface, a non-return ring 15b, a stopper 15c having a ring part 15g and hook parts 15h, a pressure piston 15d, and urging means 15e.

As shown in FIG. 3, the pressure piston 15d is slidably inserted inside the torpedo piston 15a in a state where a gap between an inner circumferential surface of the torpedo piston 15a and an outer circumferential surface of the pressure piston 15d is closed by a seal member 15i. In this case, as shown in FIG. 5, FIG. 7, and FIG. 8, an entry part 15j for the molten resin to enter may be formed also in an end surface of the pressure piston 15d on the Z-axis minus side.

The first drive part 16 drives the first piston unit 14 in the Z-axis direction. As shown in FIG. 3, the first drive part 16 includes a motor 16a, a threaded shaft 16b, a slider 16c, a rod 16d, and a case 16e. The motor 16a is a servomotor, for example, and is fixed at an end of the case 16e on the Z-axis plus side. A rotation angle of an output shaft of the motor 16a is detected by an encoder 16f (see FIG. 2).

As shown in FIG. 3, the threaded shaft 16b extends in the Z-axis direction and is rotatably supported inside the case 16e through a bearing 16g. An end of the threaded shaft 16b on the Z-axis plus side is connected to the output shaft of the motor 16a, so as to be able to transmit drive power from the output shaft, in a state of being passed through a through-hole 16h that is formed at the end of the case 16e on the Z-axis plus side.

The slider 16c includes a threaded hole, and the threaded hole of the slider 16c meshes with the threaded shaft 16b such that the slider 16c moves inside the case 16e along the threaded shaft 16b. The threaded shaft 16b and the slider 16c constitute a ball screw and are housed inside the case 16e.

As shown in FIG. 3, the rod 16d extends in the Z-axis direction and is passed through a through-hole 16i formed at an end of the case 16e on the Z-axis minus side and the through-hole 11c of the first cylinder 11. An end of the rod 16d on the Z-axis plus side is fixed on the slider 16c, and an end of the rod 16d on the Z-axis minus side is fixed on the end of the torpedo piston 14a of the first piston unit 14 on the Z-axis plus side.

As shown in FIG. 3, the case 16e supports the motor 16a, the threaded shaft 16b, the slider 16c, and the rod 16d. For example, the case 16e has a box shape and an enclosed space is formed inside the case 16e. The closing part 11a of the first cylinder 11 is fixed at the end of the case 16e on the Z-axis minus side.

The second drive part 17 drives the second piston unit 15 in the Z-axis direction. The second drive part 17 has substantially the same configuration as the first drive part 16 and therefore overlapping description thereof will be omitted. As shown in FIG. 3, the second drive part 17 includes a motor 17a, a threaded shaft 17b, a slider 17c, a rod 17d, and a case 17e.

Specifically, the motor 17a is fixed at an end of the case 17e on the Z-axis plus side, and a rotation angle of an output shaft of the motor 17a is detected by an encoder 17f (see FIG. 2). As shown in FIG. 3, the threaded shaft 17b is supported inside the case 17e through a bearing 17g, and an end of the threaded shaft 17b on the Z-axis plus side is connected to the output shaft of the motor 17a in a state where the threaded shaft 17b is passed through a through-hole 17h formed at the end of the case 17e on the Z-axis plus side.

The slider 17c has a threaded hole that meshes with the threaded shaft 17b such that the slider 17c moves inside the case 17e along the threaded shaft 17b. The rod 17d is passed through a through-hole 17i formed at an end of the case 17e on the Z-axis minus side and the through-hole 12c of the second cylinder 12. An end of the rod 17d on the Z-axis plus side is fixed on the slider 17c, and an end of the rod 17d on the Z-axis minus side is fixed on the end of the torpedo piston 15a of the second piston unit 15 on the Z-axis plus side.

As shown in FIG. 3, the case 17e supports the motor 17a, the threaded shaft 17b, the slider 17c, and the rod 17d and an enclosed space is formed inside the case 17e. The closing part 12a of the second cylinder 12 is fixed at the end of the case 17e on the Z-axis minus side.

In this embodiment, as shown in FIG. 1 and FIG. 3, the case 17e is integrally formed with the case 16e of the first drive part 16 to form a common enclosed space. In the following description, therefore, when the case 16e of the first drive part 16 is shown, the case 17e of the second drive part 17 may also be shown. Alternatively, the case 17e may be formed by a member separate from the case 16e of the first drive part 16.

The injection part 18 is disposed on the Z-axis minus side relatively to the end plate 13 so as to be able to inject the molten resin extruded from the first cylinder 11 and the second cylinder 12. As shown in FIG. 3, the injection part 18 includes an injection port 18a (a resin discharge hole, corresponding to the discharge nozzle of the present disclosure; hereinafter also referred to as a discharge nozzle 18a or a nozzle 18a) through which the molten resin is injected, a first branch passage 18b that extends from the injection port 18a toward a side that is the Z-axis plus side as well as the Y-axis minus side, and a second branch passage 18c that extends from the injection port 18a toward a side that is the Z-axis plus side as well as the Y-axis plus side. Here, the injection port 18a may be shaped such that the diameter thereof decreases toward the Z-axis minus side.

As shown in FIG. 3, the injection part 18 is fixed on the end plate 13 through a retaining nut 18d. In this case, an end of the first branch passage 18b on the Z-axis plus side communicates with the through-hole 13c of the end plate 13 on the Y-axis minus side, and an end of the second branch passage 18c on the Z-axis plus side communicates with the through-hole 13c of the end plate 13 on the Y-axis plus side.

The injection part 18 is divided into a first plate 18e in which the injection port 18a is formed and a second plate 18f in which the first branch passage 18b and the second branch passage 18c are formed. While detailed functions of the injection part 18 will be described later, at least one of the first plate 18e and the second plate 18f may be formed by a ceramic plate. Here, a housing part that houses part of the non-return valve 13b can be formed in the injection part 18.

As will be described in detail later, the first control part 19 controls the motor 16a of the first drive part 16 and the motor 17a of the second drive part 17 based on detection results of the encoders 16f, 17f.

The supply device 3 supplies the resin material to the first cylinder 11 and the second cylinder 12. As shown in FIG. 1 to FIG. 3, the supply device 3 includes an exhaust part 31, hoppers 32, a pressurization part 33, and a second control part 34. The exhaust part 31 discharges gas from the first space S1 of the first cylinder 11, a first space S3 of the second cylinder 12 located on the Z-axis plus side relatively to the second piston unit 15, and spaces surrounded by the torpedo pistons 14a, 15a and the pressure pistons 14d, 15d.

Specifically, the exhaust part 31 includes exhaust passages 31a, an exhaust hole 31b, and an exhaust valve 31c. As shown in FIG. 3, one exhaust passage 31a is formed in the rod 16d of the first drive part 16 and the torpedo piston 14a, and the other exhaust passage 31a is formed in the rod 17d of the second drive part 17 and the torpedo piston 15a. The exhaust passages 31a extend in the Z-axis direction by passing through insides of the rods 16d, 17d and extending through the ends of the torpedo pistons 14a, 15a on the Z-axis plus side.

Ends of the exhaust passages 31a on the Z-axis minus side are divided so as to reach circumferential surfaces of the ends of the rods 16d, 17d on the Z-axis minus side and the spaces surrounded by the torpedo pistons 14a, 15a and the pressure pistons 14d, 15d, while ends of the exhaust passages 31a on the Z-axis plus side reach end surfaces of the rods 16d, 17d on the Z-axis plus side.

Thus, the end of each exhaust passage 31a on the Z-axis minus side communicates with the first space S1 of the first cylinder 11 and the space surrounded by the torpedo piston 14a and the pressure piston 14d, or with the first space S3 of the second cylinder 12 and the space surrounded by the torpedo piston 15a and the pressure piston 15d, while the end of each exhaust passage 31a on the Z-axis plus side is disposed inside the case 16e of the first drive part 16.

The exhaust hole 31b is formed in the case 16e of the first drive part 16. When the case 16e of the first drive part 16 and the case 17e of the second drive part 17 are formed by separate members, the exhaust hole 31b is formed in each of the cases 16e, 17e.

The exhaust valve 31c is connected to the exhaust hole 31b through an exhaust pipe 35. The exhaust valve 31c is, for example, an electromagnetic valve.

The hoppers 32 house a resin material M to be supplied to the first space S1 of the first cylinder 11 and the first space S3 of the second cylinder 12. In this embodiment, as shown in FIG. 1, the hoppers 32 include a first hopper 32a and a second hopper 32b.

The first hopper 32a is configured such that an inside of the first hopper 32a can be enclosed, and is connected to the supply hole 11d of the first cylinder 11 through a first supply pipe 36. The second hopper 32b is configured such that an inside of the second hopper 32b can be enclosed, and is connected to the supply hole 12d of the second cylinder 12 through a second supply pipe 37.

At a minimum, the first hopper 32a and the second hopper 32b should be configured such that the resin material M can be maintained in a dry state by a residual-heat heater. This can reduce the likelihood of shaping failure due to water vapor generated during plasticization of the resin material M.

The inside diameters of the supply hole 11d of the first cylinder 11, the supply hole 12d of the second cylinder 12, the first supply pipe 36, and the second supply pipe 37 may be equal to or smaller than twice the length of the diagonal line of resin pellets constituting the resin material M.

This can reduce the likelihood that the pellets of the resin material M may cause a bridging phenomenon by lying side by side and thereby clog an inside of the supply hole 11d of the first cylinder 11, the supply hole 12d of the second cylinder 12, the first supply pipe 36, or the second supply pipe 37.

The pressurization part 33 is an air pump that pressurizes the insides of the hoppers 32 with gas. In this embodiment, as shown in FIG. 1, the pressurization part 33 is connected to the first hopper 32a through a first connection pipe 38 and connected to the second hopper 32b through a second connection pipe 39.

The pressurization part 33 pressurizes the insides of the hoppers 32, for example, at all times. Therefore, in a state where the exhaust valve 31c and the non-return valves 13b of the end plate 13 are closed, an enclosed space formed by a space surrounded by the first cylinder 11, the second cylinder 12, the torpedo pistons 14a, 15a, and the pressure pistons 14d, 15d, and the case 16e of the first drive part 16 is maintained at a high pressure compared with an outside of the case 16e.

The second control part 34 controls the exhaust valve 31c so as to discharge gas from the first space S1 of the first cylinder 11 or the first space S3 of the second cylinder 12 at a desired timing to be described later.

As shown in FIG. 1, the table 4 is a molding base which is disposed on the Z-axis minus side relatively to the injection molding machine 2 and on which the molten resin injected through the injection port 18a of the injection molding machine 2 is layered to mold a workpiece. The molten resin injected (discharged) through the injection port 18a is called resin beads (the molten resin discharged through the injection port 18a and solidified into a thread-like form). Here, for example, the table 4 may be configured to be capable of heating. The moving device 5 moves the injection molding machine 2 and the table 4 to mold a workpiece. As shown in FIG. 1 and FIG. 2, the moving device 5 includes, for example, a gantry device 51, a raising-lowering device 52, and a third control part 53.

The gantry device 51 moves the injection molding machine 2 in the X-axis direction and the Y-axis direction. As the gantry device 51, a common gantry device can be used; for example, the gantry device 51 can be formed by combining a slide rail extending in the X-axis direction and a slide rail extending in the Y-axis direction. As the gantry device 51, a device that moves the injection molding machine 2 in the X-axis direction, the Y-axis direction, and the Z-axis direction may be used.

The raising-lowering device 52 raises and lowers the table 4 in the Z-axis direction. As the raising-lowering device 52, for example, a common raising-lowering device can be used, and the raising-lowering device 52 can be formed by a ball screw. The third control part 53 controls the gantry device 51 and the raising-lowering device 52 to mold a desired workpiece by layering the molten resin injected from the injection molding machine 2.

As shown in FIG. 1 to FIG. 3, the heating device 6 includes first heating parts 61, a second heating part 62, a temperature detection part 63, and a fourth control part 64. The first heating parts 61 keep the plasticized molten resin warm.

The first heating parts 61 can be formed by, for example, sheet heaters that surround parts of the first cylinder 11 and the second cylinder 12 on the Z-axis minus side. However, the first heating parts 61 should at a minimum be able to keep the plasticized molten resin warm, and the configuration and arrangement of the first heating parts 61 are not limited.

The second heating part 62 heats the molten resin to a desired temperature. As shown in FIG. 3 and FIG. 6, the second heating part 62 includes, for example, sheet heaters 62a and a heat transfer member 62b. As seen from the Z-axis direction, the sheet heaters 62a are disposed at substantially regular intervals around the injection port 18a of the injection part 18. The heat transfer member 62b has a disc shape with a through-hole formed substantially at the center thereof, and is formed by a ceramic plate.

The heat transfer member 62b is disposed between the first plate 18e and the second plate 18f. In this case, the sheet heaters 62a are disposed between the heat transfer member 62b and the first plate 18e or between the heat transfer member 62b and the second plate 18f. Thus, the heat of the sheet heaters 62a can be appropriately transferred to the first plate 18e or the second plate 18f.

Here, when the first plate 18e and the second plate 18f are formed by ceramic plates as mentioned above, since the heat capacity of ceramic plates is low compared with that of metal, the heat of the second heating part 62 can be efficiently transferred to the molten resin. When the second heating part 62 is damaged, the second heating part 62 can be easily replaced by loosening the retaining nut 18d.

The temperature detection part 63 detects the temperature of molten resin. The temperature detection part 63 is provided, for example, in the injection part 18. In this case, the temperature detection part 63 may be provided on one of the first plate 18e and the second plate 18f that is formed by a ceramic plate. Thus, the temperature of the molten resin can be accurately detected.

The fourth control part 64 controls the first heating parts 61 and the second heating part 62 based on a detection result of the temperature detection part 63 such that the temperature of the molten resin remains within a preset range. The heating device 6 may be omitted when the first cylinder 11 and the second cylinder 12 are configured to be able to keep the molten resin R warm.

As shown in FIG. 2, the control device 7 includes the first control part 19, the second control part 34, the third control part 53, and the fourth control part 64, and controls the first control part 19, the second control part 34, the third control part 53, and the fourth control part 64 to mold workpieces.

Next, conditions in the injection molding apparatus 1 of the embodiment will be described that are preferred in reducing the likelihood that gas may flow into the second space S2 of the first cylinder 11 or a second space S4 of the second cylinder 12 located on the Z-axis minus side relatively to the second piston unit 15 in the process of making the molten resin flow into the second space S2 of the first cylinder 11 or the second space S4 of the second cylinder 12 while plasticizing the resin material M having been supplied to the first space S1 of the first cylinder 11 or the first space S3 of the second cylinder 12.

First, the area of a region surrounded by an outer circumferential edge of the pressure piston 14d of the first piston unit 14 in an XY-cross-section should be equal to or larger than the area of a region surrounded by an outer circumferential edge of the rod 16d in an XY-cross-section. Similarly, the area of a region surrounded by an outer circumferential edge of the pressure piston 15d of the second piston unit 15 in an XY-cross-section should be equal to or larger than the area of a region surrounded by an outer circumferential edge of the rod 17d in an XY-cross-section.

The volume of the second space S2 of the first cylinder 11 in a state where, to inject the molten resin, the torpedo piston 14a is disposed farthest on the Z-axis plus side and the pressure piston 14d is disposed in the second space S2 should be equal to or smaller than the volume of the first space S1 of the first cylinder 11 in a state where, to plasticize the resin material M, the torpedo piston 14a is disposed farthest on the Z-axis minus side and the rod 16d is disposed in the first space S1.

Similarly, the volume of the second space S4 of the second cylinder 12 in a state where, to inject the molten resin, the torpedo piston 15a is disposed farthest on the Z-axis plus side and the pressure piston 15d is disposed in the second space S4 should be equal to or smaller than the volume of the first space S3 of the second cylinder 12 in a state where, to plasticize the resin material M, the torpedo piston 15a is disposed farthest on the Z-axis minus side and the rod 17d is disposed in the first space S3.

It is preferable that the following <Expression 1> to <Expression 3> be further satisfied:

(π×(Dc²−Dr²)×Lr×γ)/4≥(π×(Dc²−Dp²)×Lr)/4 <Expression 1>

π×Lr×{(Dc²−Dr²)×γ−(Dc²−Dp²)}/4 ≤π×Dp²×Lp/4 <Expression 2>

(Dc²−DP²)/(Dc²−Dr²)≤γ≤Dp²/(Dc²−Dr²)×Lp/Lr+(Dc²−Dp²)/(Dc²−Dr²) <Expression 3>

Here, Dc is the inside diameter of the first cylinder 11 and the second cylinder 12; Dp is the outside diameter of the pressure pistons 14d, 15d; Dr is the outside diameter of the rods 16d, 17d; Lp is a maximum stroke amount (maximum amount of movement) of the pressure pistons 14d, 15d; Lr is a maximum stroke amount (maximum amount of movement) of the torpedo pistons 14a, 15a; and γ is a filling rate of the resin material M.

As shown in <Expression 1>, the volume of the resin material M supplied to the first space S1 of the first cylinder 11 or the first space S3 of the second cylinder 12 should be equal to or larger than an amount of increase in the volume of the second space S2 of the first cylinder 11 or the second space S4 of the second cylinder 12 at the time of plasticizing the resin material M.

Here, the volume of the resin material M is substantially equal to the volume of the molten resin. Therefore, the above condition can be rephrased as follows: the volume of the molten resin flowing into the second space S2 of the first cylinder 11 or the second space S4 of the second cylinder 12 should be equal to or larger than an amount of increase in the volume of the second space S2 of the first cylinder 11 or the second space S4 of the second cylinder 12 at the time of inflow of the molten resin.

As shown in <Expression 2>, an amount by which the volume of the second space S2 of the first cylinder 11 or the second space S4 of the second cylinder 12 can increase as the pressure pistons 14d, 15d move toward the Z-axis plus side from a state of being disposed farthest on the Z-axis minus side should be equal to or larger than the difference obtained by subtracting an amount of increase in the volume of the second space S2 of the first cylinder 11 or the second space S4 of the second cylinder 12 from the volume of the molten resin.

Thus, the amount of molten resin obtained by subtracting the amount of increase in the volume of the second space S2 of the first cylinder 11 or the second space S4 of the second cylinder 12 from the volume of the molten resin according to <Expression 1> can be absorbed as the pressure pistons 14d, 15d move toward the Z-axis plus side.

<Expression 3> is a result of solving <Expression 1> and <Expression 2> in terms of the filling rate of the resin material M. Even when the type of the resin material M or the like is different, satisfying <Expression 3> can reduce the likelihood of inflow of gas into the second space S2 of the first cylinder 11 or the second space S4 of the second cylinder 12.

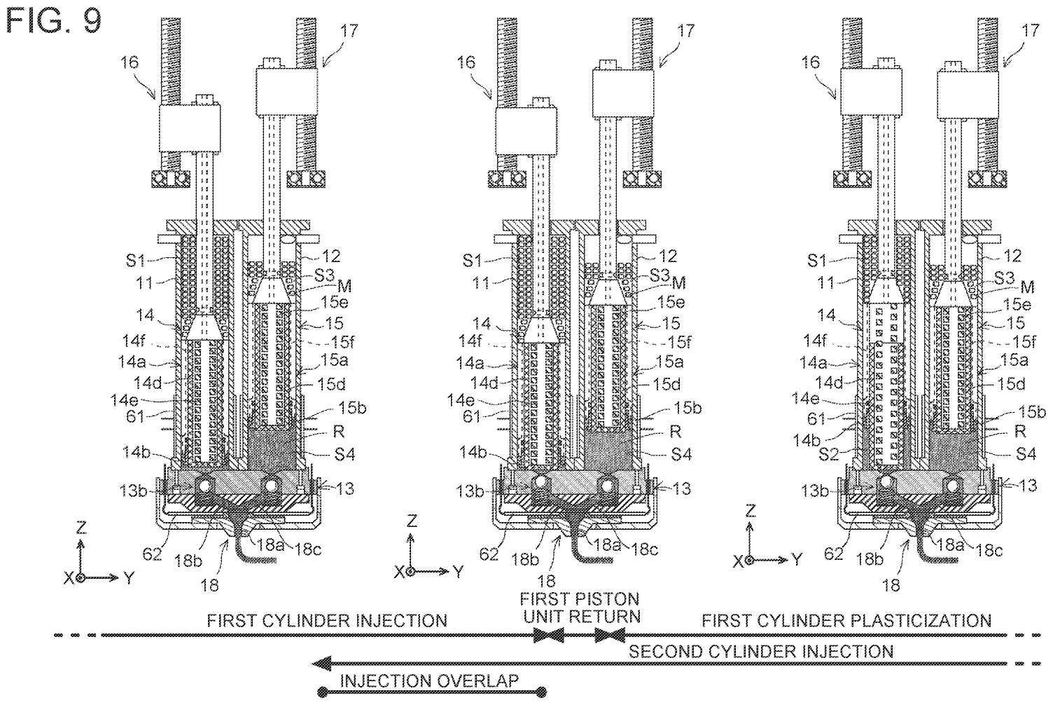

Next, the flow of molding a workpiece using the injection molding apparatus 1 of the embodiment will be described. FIG. 9 to FIG. 13 are views showing the operation of the injection molding apparatus of the embodiment. In FIG. 9 to FIG. 13, the operation of the injection molding machine 2 is shown at the top, and timings of plasticization of the resin material M in the first cylinder 11 and the second cylinder 12, injection of the molten resin R, etc. are shown at the bottom.

Here, in the state on the left side of FIG. 9, the first piston unit 14 is moving toward the Z-axis minus side and injecting the molten resin R having flowed into the second space S2 of the first cylinder 11 in a state where supply of the resin material M from the first hopper 32a of the supply device 3 to the first space S1 of the first cylinder 11 has been completed.

Meanwhile, the second piston unit 15 is moving toward the Z-axis minus side and starting to inject the molten resin R from the second space S4 of the second cylinder 12. In this case, it is assumed that the pressure piston 15d of the second piston unit 15 is disposed farthest on the Z-axis plus side. Further, it is assumed that the exhaust valve 31c of the exhaust part 31 is closed.

From this state, the first control part 19 controls the motor 16a such that the first piston unit 14 continues to move toward the Z-axis minus side and continues to inject the molten resin R, and at the same time controls the motor 17a such that the second piston unit 15 continues to move toward the Z-axis minus side and continues to inject the molten resin R.

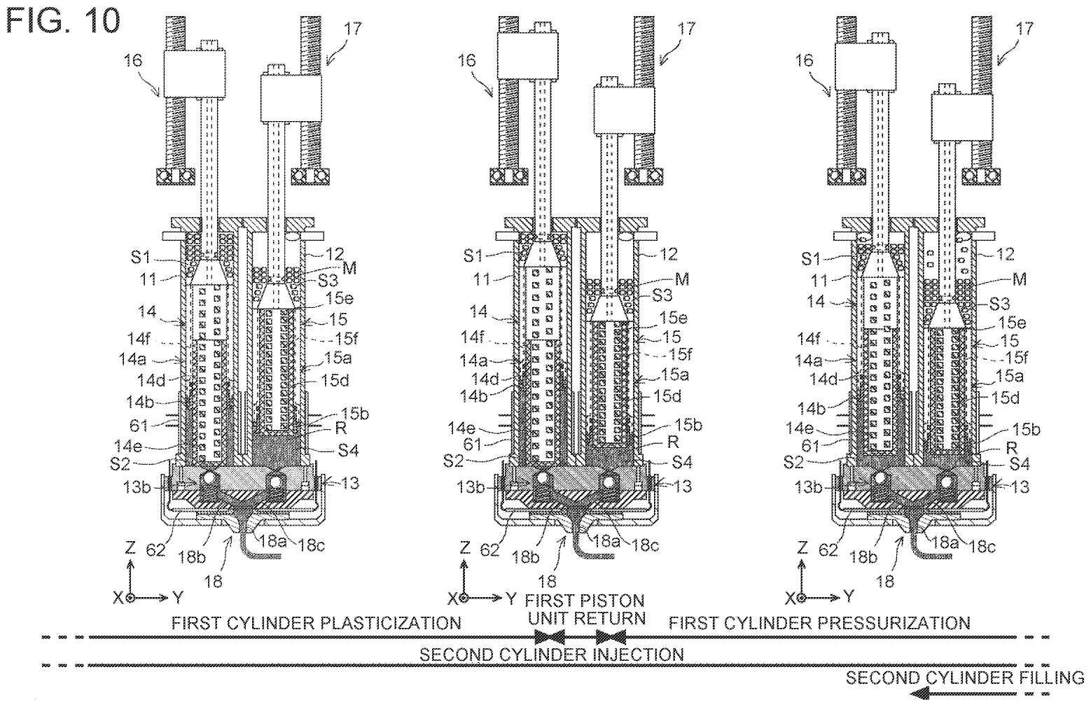

Next, the first control part 19 confirms that the first piston unit 14 has reached a farthest point on the Z-axis minus side (bottom dead center) with reference to a detection result of the encoder 16f, and then controls the motor 16a such that the first piston unit 14 starts to move toward the Z-axis plus side as shown at the center of FIG. 9, on the right side of FIG. 9, and on the left side of FIG. 10.

Thus, during the period from when injection of the molten resin R from the second cylinder 12 is started until injection of the molten resin R from the first cylinder 11 is stopped, the molten resin R is injected from the first cylinder 11 and the second cylinder 12.

Therefore, the period during which the molten resin R is injected from the second cylinder 12 can be overlapped with the period during which the molten resin R is injected from the first cylinder 11 for the duration of a preset first period. Thus, the molten resin R can be continuously injected from the first cylinder 11 and the second cylinder 12.

Here, the preset first period can be set as appropriate according to the moving speed of each of the piston units 14, 15. A desired workpiece can be accurately molded as the first control part 19 controls the motors 16a, 17a and adjusts the moving speed of each of the piston units 14, 15 such that the injection amount of the molten resin R injected from the injection part 18 meets a target injection amount.

When the first piston unit 14 starts to move toward the Z-axis plus side, the resin material M is compressed by the first piston unit 14, the closing part 11a of the first cylinder 11, and the side wall 11b of the first cylinder 11. Thus, the resin material M is plasticized into the molten resin R while passing through the grooves 14f of the torpedo piston 14a of the first piston unit 14 and flows into the second space S2 of the first cylinder 11.

In this case, since the supply hole 11d is formed in the side wall 11b of the first cylinder 11, the resin material M is less likely to leak out through the supply hole 11d. Moreover, a force acting toward the Z-axis plus side while the resin material M is plasticized by the first piston unit 14 can be borne by the closing part 11a of the first cylinder 11.

When the surface of the torpedo piston 14a of the first piston unit 14 on the Z-axis plus side is formed as a sloping surface that slopes toward the Z-axis minus side while spreading from the center of the torpedo piston 14a toward the circumferential edge thereof, the resin material M can be appropriately guided to the grooves 14f of the torpedo piston 14a of the first piston unit 14 when the first piston unit 14 moves toward the Z-axis plus side.

When the first piston unit 14 moves toward the Z-axis plus side, the non-return ring 14b of the first piston unit 14 is pushed toward the Z-axis minus side, which allows the molten resin R to flow appropriately from the through-hole of the non-return ring 14b into the second space S2 of the first cylinder 11 through a gap between the torpedo piston 14a and the non-return ring 14b.

When the first piston unit 14 thus moves toward the Z-axis plus side, the pressure piston 14d is protruded toward the Z-axis minus side relatively to the torpedo piston 14a by the urging force of the urging means 14e such that the end of the pressure piston 14d on the Z-axis minus side remains in contact with the end plate 13.

In this embodiment, the area of the region surrounded by the outer circumferential edge of the pressure piston 14d in the XY-cross-section is equal to or larger than the area of the region surrounded by the outer circumferential edge of the rod 16d in the XY-cross-section, and the volume of the second space S2 of the first cylinder 11 in the state where, to inject the molten resin R, the torpedo piston 14a is disposed farthest on the Z-axis plus side and the pressure piston 14d is disposed in the second space S2 is equal to or smaller than the volume of the first space S1 of the first cylinder 11 in the state where, to plasticize the resin material M, the torpedo piston 14a is disposed farthest on the Z-axis minus side and the rod 16d is disposed in the first space S1.

Therefore, the pressure piston 14d is urged by the urging means 14e such that, when the torpedo piston 14a moves toward the Z-axis plus side, an increase in the volume of the second space S2 of the first cylinder 11 becomes equal to or smaller than an amount of decrease in the volume of the first space 51 of the first cylinder 11. This can reduce the likelihood that gas may flow into the second space S2 of the first cylinder 11 when the molten resin R flows into the second space S2.

Meanwhile, the first control part 19 controls the motor 17a with reference to a detection result of the encoder 17f such that the second piston unit 15 continues to move toward the Z-axis minus side. Thus, while pushing the non-return valve 13b of the end plate 13 on the Y-axis plus side toward the Z-axis minus side, the molten resin R is injected through the through-hole 13c on the Y-axis plus side and the second branch passage 18c and the injection port 18a of the injection part 18. Here, the non-return valve 13b on the Y-axis minus side blocks the flow of the molten resin R toward the Z-axis plus side by the pressure of the molten resin R injected from the second cylinder 12.

When the second piston unit 15 moves toward the Z-axis minus side, the non-return ring 15b of the second piston unit 15 is pushed toward the Z-axis plus side and the grooves 15f of the torpedo piston 15a are closed by the non-return ring 15b. This can reduce the likelihood that the molten resin R may flow back to the first space S3 of the second cylinder 12 through the grooves 15f of the torpedo piston 15a.

Next, the first control part 19 confirms that the first piston unit 14 has reached the farthest point on the Z-axis plus side with reference to the encoder 16f, and then controls the motor 16a such that the first piston unit 14 starts to move toward the Z-axis minus side as shown at the center of FIG. 10. Meanwhile, the first control part 19 controls the motor 17a with reference to the encoder 17f such that the second piston unit 15 continues to move toward the Z-axis minus side.

Here, the pressure piston 14d of the first piston unit 14 is in a state of having protruded from the torpedo piston 14a farthest toward the Z-axis minus side, and, as the first piston unit 14 moves toward the Z-axis minus side, the pressure on the molten resin R inside the second space S2 of the first cylinder 11 rises.

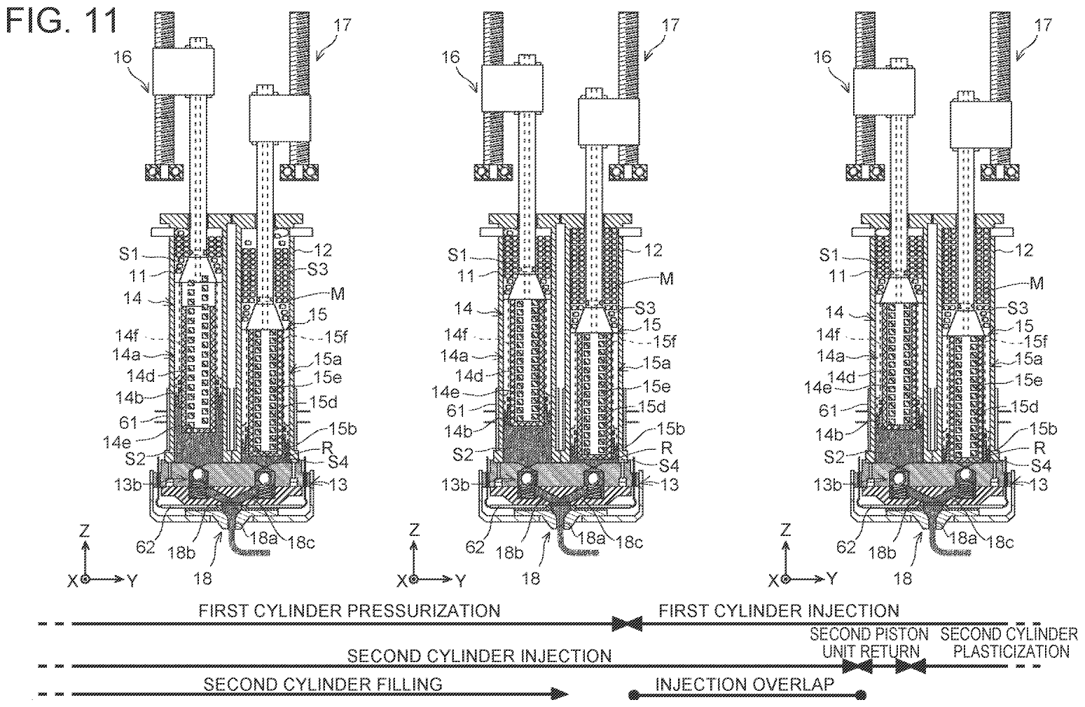

As the molten resin R in the second space S2 of the first cylinder 11 enters the entry part 14j of the pressure piston 14d, the force of the pressure on the molten resin R exceeds the urging force of the urging means 14e, so that the pressure piston 14d is pushed toward the Z-axis minus side as shown on the right side of FIG. 10, on the left side of FIG. 11, and at the center of FIG. 11. At this point, gas inside the space surrounded by the torpedo piston 14a and the pressure piston 14d is exhausted through the exhaust passage 31a into the case 16e by an amount corresponding to the decrease in the volume of this space.

Meanwhile, the first control part 19 confirms that the second piston unit 15 has reached a preset position in the Z-axis direction with reference to the encoder 17f, and then the second control part 34 controls the exhaust valve 31c of the exhaust part 31 such that the exhaust valve 31c opens.

Thus, gas in the first space S3 of the second cylinder 12 enters inside the case 16e through the exhaust passage 31a of the rod 17d and is discharged through the exhaust hole 31b and the exhaust valve 31c. As a result, a flow of gas flowing from the second hopper 32b into the first space S3 of the second cylinder 12 occurs. Pushed by this gas, the resin material M is supplied from the second hopper 32b to the first space S3 of the second cylinder 12 through the supply hole 12d of the second cylinder 12 as shown on the right side of FIG. 10, on the left side of FIG. 11, and at the center of FIG. 11.

Since the supply hole 12d is formed in the side wall 12b of the second cylinder 12, the resin material M falls toward the Z-axis minus side while swirling along with the gas. Thus, the resin material M can be supplied substantially evenly into the first space S3 of the second cylinder 12.

Next, the pressure piston 14d reaches the farthest point on the Z-axis plus side (e.g., the end of the pressure piston 14d on the Z-axis plus side contacts the end of the torpedo piston 14a on the Z-axis plus side), and the pressure with which the molten resin R is pushed toward the Z-axis minus side by the end of the first piston unit 14 on the Z-axis minus side reaches a preset pressure. Then, the non-return valve 13b of the end plate 13 on the Y-axis minus side opens.

Thus, while pushing the non-return valve 13b of the end plate 13 on the Y-axis minus side toward the Z-axis minus side, the molten resin R is injected through the through-hole 13c on the Y-axis minus side and the first branch passage 18b and the injection port 18a of the injection part 18.

In this case, when the first piston unit 14 moves toward the Z-axis minus side, the non-return ring 14b of the first piston unit 14 is pushed toward the Z-axis plus side and the grooves 14f of the torpedo piston 14a are closed by the non-return ring 14b. This can reduce the likelihood that the molten resin R may flow back to the first space S1 of the first cylinder 11 through the grooves 14f of the torpedo piston 14a.

Meanwhile, the first control part 19 confirms that the second piston unit 15 has reached near the farthest point on the Z-axis minus side with reference to the encoder 17f, and then the second control part 34 controls the exhaust valve 31c of the exhaust part 31 such that the exhaust valve 31c closes. Here, the first space S3 of the second cylinder 12 is filled with the resin material M.

Thus, the resin material M can be automatically supplied to the first space S3 of the second cylinder 12 by simply opening the exhaust valve 31c of the exhaust part 31. In this case, the resin material M is supplied to the first space S3 of the second cylinder 12 during the time from when the second piston unit 15 reaches the preset position in the Z-axis direction until it reaches near the farthest point on the Z-axis minus side, so that the resin material M can be supplied to the second cylinder 12 in a quantitative manner.

The period during which the resin material M is supplied to the first space S3 of the second cylinder 12 and the period during which the molten resin R is injected from the second cylinder 12 can be overlapped with each other for the duration of a preset second period.

Therefore, injection of the molten resin R from the second cylinder 12 and supply of the resin material M to the second cylinder 12 can be efficiently repeated. Here, the preset second period can be set as appropriate according to the moving speed of the second piston unit 15, the timing of opening the exhaust valve 31c of the exhaust part 31, etc.

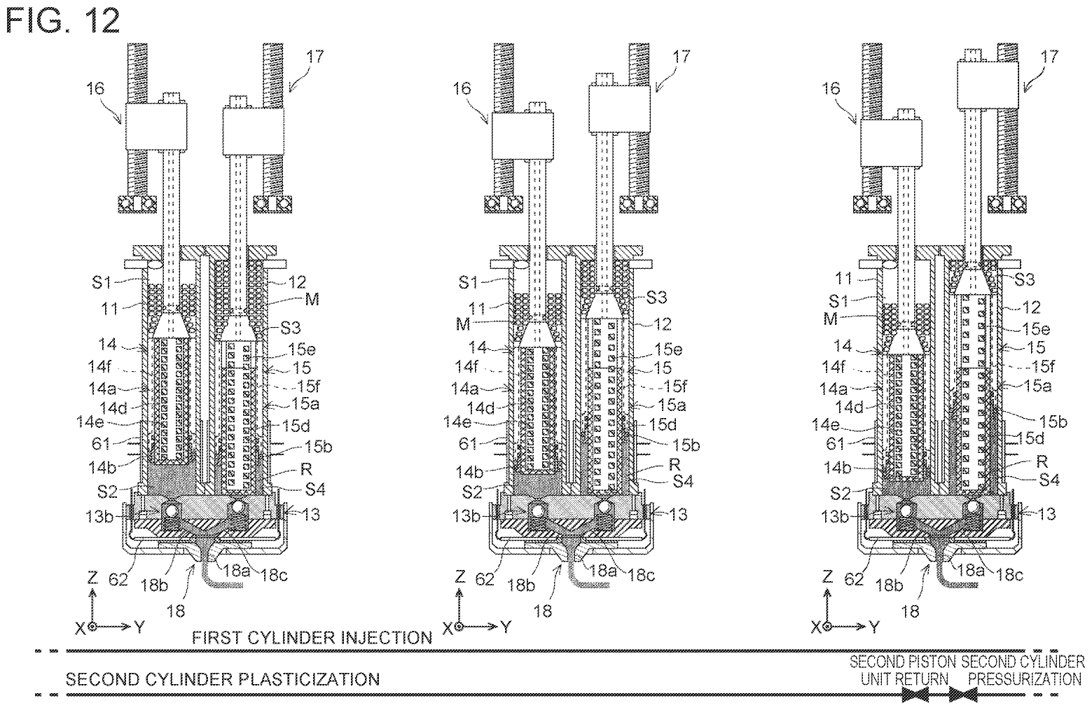

Next, the first control part 19 confirms that the second piston unit 15 has reached the farthest point on the Z-axis minus side (bottom dead center) with reference to the encoder 17f, and then controls the motor 17a such that the second piston unit 15 starts to move toward the Z-axis plus side as shown on the right side of FIG. 11, on the left side of FIG. 12, and at the center of FIG. 12. Here, the non-return valve 13b on the Y-axis plus side blocks the flow of the molten resin R toward the Z-axis plus side by the pressure of the molten resin R injected from the first cylinder 11.

Thus, compressed by the second piston unit 15, the closing part 12a of the second cylinder 12, and the side wall 12b of the second cylinder 12, the resin material M is plasticized into the molten resin R while passing through the grooves 15f of the torpedo piston 15a of the second piston unit 15 and flows into the second space S4 of the second cylinder 12.

In this case, since the supply hole 12d is formed in the side wall 12b of the second cylinder 12, the resin material M is less likely to leak out through the supply hole 12d. Further, a force that acts toward the Z-axis plus side while the resin material M is plasticized by the second piston unit 15 can be borne by the closing part 12a of the second cylinder 12.

When the surface of the torpedo piston 15a of the second piston unit 15 on the Z-axis plus side is formed as a sloping surface that slopes toward the Z-axis minus side while spreading from the center of the torpedo piston 15a toward the circumferential edge thereof, the resin material M can be appropriately guided to the grooves 15f of the torpedo piston 15a of the second piston unit 15 when the second piston unit 15 moves toward the Z-axis plus side.

When the second piston unit 15 moves toward the Z-axis plus side, the non-return ring 15b of the second piston unit 15 is pushed toward the Z-axis minus side, which allows the molten resin R to flow appropriately from the through-hole of the non-return ring 15b into the second space S4 of the second cylinder 12 through a gap between the torpedo piston 15a and the non-return ring 15b.

When the second piston unit 15 thus moves toward the Z-axis plus side, the pressure piston 15d is protruded toward the Z-axis minus side relatively to the torpedo piston 15a by the urging force of the urging means 15e such that the end of the pressure piston 15d on the Z-axis minus side remains in contact with the end plate 13.

In this embodiment, the area of the region surrounded by the outer circumferential edge of the pressure piston 15d in the XY-cross-section is equal to or larger than the area of the region surrounded by the outer circumferential edge of the rod 17d in the XY-cross-section, and the volume of the second space S4 of the second cylinder 12 in the state where, to inject the molten resin R, the torpedo piston 15a is disposed farthest on the Z-axis plus side and the pressure piston 15d is disposed in the second space S4 is equal to or smaller than the volume of the first space S3 of the second cylinder 12 in the state where, to plasticize the resin material M, the torpedo piston 15a is disposed farthest on the Z-axis minus side and the rod 17d is disposed in the first space S3.

Therefore, the pressure piston 15d is urged by the urging means 15e such that, when the torpedo piston 15a moves toward the Z-axis plus side, the amount of increase in the volume of the second space S4 of the second cylinder 12 becomes equal to or smaller than the amount of decrease in the volume of the first space S3 of the second cylinder 12. This can reduce the likelihood that gas may flow into the second space S4 of the second cylinder 12 when the molten resin R flows into the second space S4.

Meanwhile, the first control part 19 controls the motor 16a with reference to a detection result of the encoder 16f such that the first piston unit 14 continues to move toward the Z-axis minus side. Thus, during the period from when injection of the molten resin R from the first cylinder 11 is started until injection of the molten resin R from the second cylinder 12 is stopped, the molten resin R is injected from the first cylinder 11 and the second cylinder 12.

Therefore, the period during which the molten resin R is injected from the first cylinder 11 can be overlapped with the period during which the molten resin R is injected from the second cylinder 12 for the duration of the preset first period. Thus, the molten resin R can be continuously injected from the first cylinder 11 and the second cylinder 12.

A desired workpiece can be accurately molded as the first control part 19 controls the motors 16a, 17a and adjusts the moving speed of each of the piston units 14, 15 such that the injection amount of the molten resin R injected from the injection part 18 meets the target injection amount.

Next, the first control part 19 confirms that the second piston unit 15 has reached the farthest point on the Z-axis plus side with reference to the encoder 17f as shown on the right side of FIG. 12, and then controls the motor 17a such that the second piston unit 15 starts to move toward the Z-axis minus side. Meanwhile, the first control part 19 controls the motor 16a with reference to the encoder 16f such that the first piston unit 14 continues to move toward the Z-axis minus side.

Here, the pressure piston 15d of the second piston unit 15 is in a state of having protruded from the torpedo piston 15a farthest toward the Z-axis minus side, and as the second piston unit 15 moves toward the Z-axis minus side, the pressure on the molten resin R inside the second space S4 of the second cylinder 12 rises.

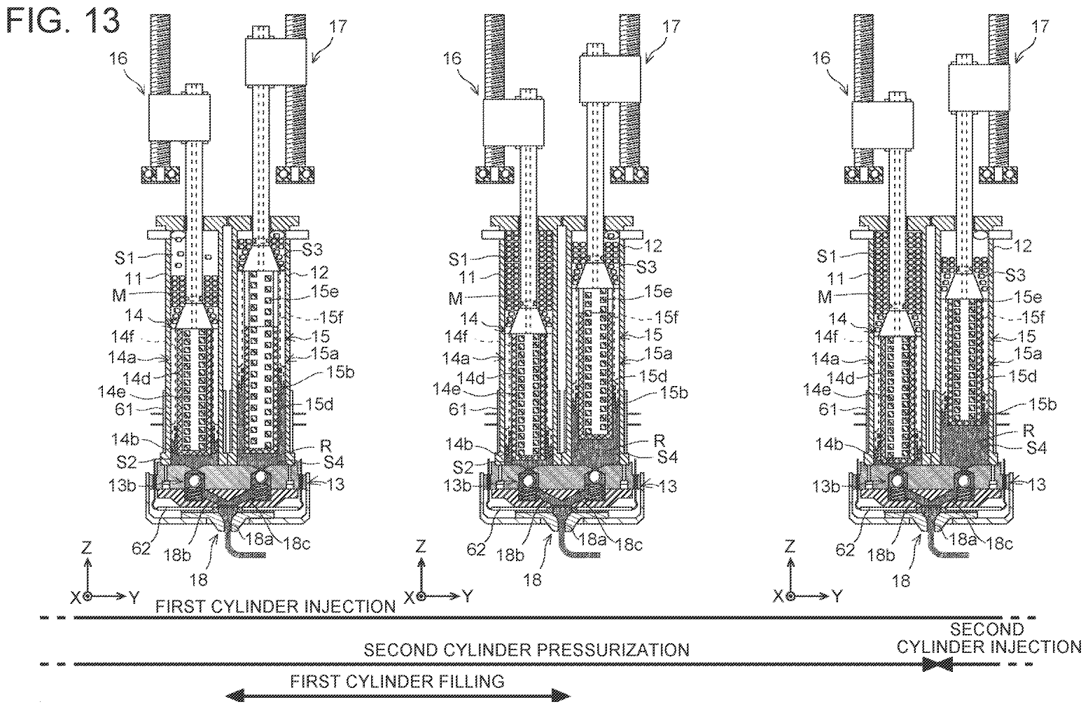

As the molten resin R in the second space S4 of the second cylinder 12 enters the entry part 15j of the pressure piston 15d, the force of the pressure on the molten resin R exceeds the urging force of the urging means 15e, so that the pressure piston 15d is pushed toward the Z-axis minus side as shown on the left side of FIG. 13. At this point, gas inside the space surrounded by the torpedo piston 15a and the pressure piston 15d is discharged into the case 16e through the exhaust passage 31a by an amount corresponding to the decrease in the volume of that space.

Meanwhile, the control part 19 confirms that the first piston unit 14 has reached a preset position in the Z-axis direction with reference to the encoder 16f, and then the second control part 34 controls the exhaust valve 31c of the exhaust part 31 such that the exhaust valve 31c opens.

Thus, gas in the first space S1 of the first cylinder 11 enters inside the case 16e through the exhaust passage 31a of the rod 16d and is discharged through the exhaust hole 31b and the exhaust valve 31c. As a result, a flow of gas flowing from the first hopper 32a into the first space S1 of the first cylinder 11 occurs. Pushed by this gas, the resin material M is supplied from the first hopper 32a to the first space S1 of the first cylinder 11 through the supply hole 11d of the first cylinder 11.

In this case, since the supply hole 11d is formed in the side wall 11b of the first cylinder 11, the resin material M falls toward the Z-axis minus side while swirling along with the gas. Thus, the resin material M can be supplied substantially evenly into the first space S1 of the first cylinder 11.

Next, the first control part 19 confirms that the first piston unit 14 has reached near the farthest point on the Z-axis minus side with reference to the encoder 16f as shown at the center of FIG. 13, and then the second control part 34 controls the exhaust valve 31c of the exhaust part 31 such that the exhaust valve 31c closes. Here, the first space S1 of the first cylinder 11 is filled with the resin material M.

Thus, the resin material M can be automatically supplied to the first space S1 of the first cylinder 11 by simply opening the exhaust valve 31c of the exhaust part 31. In this case, the resin material M is supplied to the first space S1 of the first cylinder 11 during the time from when the first piston unit 14 reaches the preset position in the Z-axis direction until it reaches near the farthest point on the Z-axis minus side. Thus, the resin material M can be supplied to the first cylinder 11 in a quantitative manner.

The period during which the resin material M is supplied to the first space S1 of the first cylinder 11 and the period during which the molten resin R is injected from the first cylinder 11 can be overlapped with each other for the duration of the preset second period.

Therefore, injection of the molten resin R from the first cylinder 11 and supply of the resin material M to the first cylinder 11 can be efficiently repeated. Here, the preset second period can be set as appropriate according to the moving speed of the first piston unit 14, the timing of opening the exhaust valve 31c of the exhaust part 31, etc.

Next, the first control part 19 controls the motor 16a such that the first piston unit 14 continues to move toward the Z-axis minus side, and controls the motor 17a such that the second piston unit 15 continues to move toward the Z-axis minus side.

As shown on the right side of FIG. 13, when the state transitions to the state on the left side of FIG. 9 and the pressure piston 15d reaches the farthest point on the Z-axis plus side (e.g., the end of the pressure piston 15d on the Z-axis plus side contacts the end of the torpedo piston 15a on the Z-axis plus side), and the pressure with which the molten resin R is pushed toward the Z-axis minus side by the end of the second piston unit 15 on the Z-axis minus side reaches a preset pressure, the non-return valve 13b of the end plate 13 on the Y-axis plus side opens.

Thus, while pushing the non-return valve 13b of the end plate 13 on the Y-axis plus side toward the Z-axis minus side, the molten resin R is injected through the through-hole 13c on the Y-axis plus side and the second branch passage 18c and the injection port 18a of the injection part 18.

Thus, the first control part 19 controls the motors 16a, 17a so as to continuously inject the molten resin R from the first cylinder 11 and the second cylinder 12, while the third control part 53 controls the gantry device 51 and the raising-lowering device 52 such that a desired workpiece is additively manufactured on a surface of the table 4 on the Z-axis plus side by the injected molten resin R. As a result, a workpiece can be molded.

Meanwhile, the fourth control part 64 controls the first heating parts 61 and the second heating part 62 based on a detection result of the temperature detection part 63 such that the temperature of the injected molten resin R remains within a preset range. Thus, the molten resin R can be injected in a stable state.

The injection molding apparatus 1, the injection molding machine 2, and the injection molding method of this embodiment include the pressure pistons 14d, 15d that are slidable in the Z-axis direction such that the amounts of protrusion thereof into the second spaces S2, S4 of the first and second cylinders 11, 12 relative to the torpedo pistons 14a, 15a change, and the urging means 14e, 15e that urge the pressure pistons 14d, 15d toward the Z-axis minus side relatively to the torpedo pistons 14a, 15a.

Thus, the volumes of the second spaces S2, S4 of the first and second cylinders 11, 12 when the molten resin R flows into the second spaces S2, S4 can be reduced, which can reduce the likelihood that gas may flow into the second spaces S2, S4 while the molten resin R flows into the second spaces S2, S4. Therefore, the injection molding apparatus 1, the injection molding machine 2, and the injection molding method of this embodiment can reduce the likelihood of gas mixing into the molten resin R during injection of the molten resin R, thereby contributing to improving the quality of workpieces.

In particular, in the injection molding apparatus 1, the injection molding machine 2, and the injection molding method of this embodiment, the urging means 14e, 15e urge the pressure pistons 14d, 15d such that, when the torpedo pistons 14a, 15a move toward the Z-axis plus side, the amount of increase in the volume of the second spaces S2, S4 of the first and second cylinders 11, 12 becomes equal to or smaller than the amount of decrease in the volumes of the first spaces S1, S3 of the first and second cylinders 11, 12. This can reduce the likelihood that gas may flow into the second spaces S2, S4 of the first and second cylinders 11, 12 while the molten resin R flows into the second spaces S2, S4.

Further, in the injection molding apparatus 1, the injection molding machine 2, and the injection molding method of this embodiment, the period during which the molten resin R is injected from the first cylinder 11 and the period during which the molten resin R is injected from the second cylinder 12 are partially overlapped with each other. Thus, the molten resin R can be continuously injected from the first cylinder 11 and the second cylinder 12.

In the injection molding apparatus 1, the injection molding machine 2, and the injection molding method of this embodiment, the resin material M can be automatically supplied to the first and second cylinders 11, 12 by simply controlling the exhaust valve 31c of the exhaust part 31. Thus, the supply device 3 of this embodiment can function as an automatic supply device of the resin material M. Therefore, the resin material M can be supplied by a simple configuration.

Since the resin material M is supplied to the first cylinder 11 or the second cylinder 12 from when the first piston unit 14 or the second piston unit 15 reaches the preset position in the Z-axis direction until it reaches near the farthest point on the Z-axis minus side, the resin material M can be supplied to the first cylinder 11 and the second cylinder 12 in a quantitative manner. This can eliminate the need for a measuring instrument of the resin material M.

The preset position in the Z-axis direction may be set such that the first space S1 of the first cylinder 11 or the first space S3 of the second cylinder 12 is filled with the resin material M before the first piston unit 14 or the second piston unit 15 reaches near the farthest point on the Z-axis minus side.

Here, since the end of the first cylinder 11 on the Z-axis minus side is open, the first piston unit 14 and the rod 16d of the first drive part 16 can be inserted through the opening of the first cylinder 11 on the Z-axis minus side. Similarly, since the end of the second cylinder 12 on the Z-axis minus side is open, the second piston unit 15 and the rod 17d of the second drive part 17 can be inserted through the opening of the second cylinder 12 on the Z-axis minus side. This can eliminate the need for a plunger like the one provided in the injection molding apparatus of Japanese Patent No. 5920859.

As shown in FIG. 3, the injection molding machine 2 may include a cooling part 8 between the case 16e of the first drive part 16 and the first and second cylinders 11, 12. For example, the cooling part 8 has an annular shape as a basic form, and has a through-hole 8a which is formed so as to extend through the cooling part 8 in the Z-axis direction and through which the rod 16d or 17d is passed. The cooling part 8 has a cooling passage 8b which is formed so as to surround the through-hole 8a and through which a cooling medium flows.

In this configuration, when the cooling medium is passed through the cooling passage 8b of the cooling part 8 during molding of a workpiece by the injection molding apparatus 1, less heat from the first cylinder 11 and the second cylinder 12 transfers to the bearing 16g of the first drive part 16 and the bearing 17g of the second drive part 17. This can reduce the likelihood of temperature changes of the bearings 16g, 17g and the likelihood of malfunctioning of the bearings 16g, 17g. As a result, workpiece can be accurately molded.

### Embodiment 2

Next, the configuration of an injection molding machine 2A of Embodiment 2 will be described.

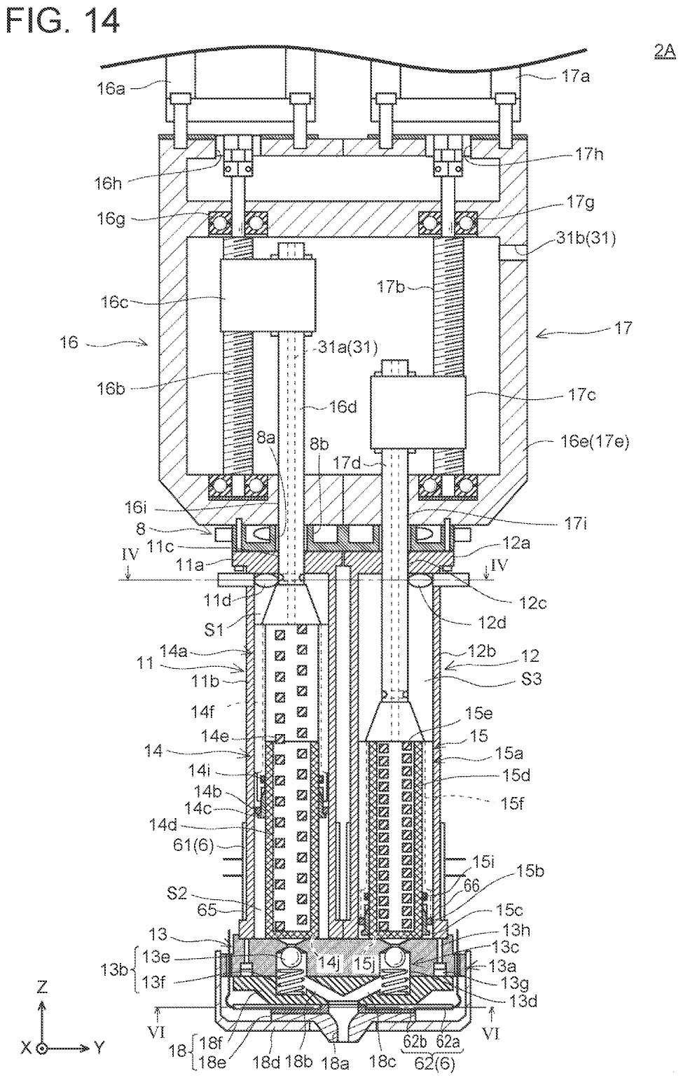

FIG. 14 is a configuration view of the injection molding machine 2A of Embodiment 2.

The configuration of the injection molding machine 2A of Embodiment 2 is the same as the configuration of the injection molding machine 2 of Embodiment 1 except for the following differences.

As shown in FIG. 14, the injection molding machine 2A of Embodiment 2 additionally has a first pressure detection part 65 and a second pressure detection part 66. The first pressure detection part 65 is a pressure detection sensor, for example, a strain gauge, that detects a pressure applied to the molten resin housed (stored) inside the first cylinder 11. The strain gauge detects the pressure from strain on an outer wall of the first cylinder 11 due to the pressure applied to the molten resin housed (stored) inside the first cylinder 11. For example, the first pressure detection part 65 is mounted (e.g., attached) at an area of an outer circumferential surface of the first cylinder 11 that corresponds to a part where the molten resin is housed. The second pressure detection part 66 is a pressure detection sensor, for example, a strain gauge, that detects a pressure applied to the molten resin housed (stored) inside the second cylinder 12. The strain gauge detects the pressure from strain on an outer wall of the second cylinder 12 due to the pressure applied to the molten resin housed (stored) inside the second cylinder 12. For example, the second pressure detection part 66 is mounted (e.g., attached) at an area of an outer circumferential surface of the second cylinder 12 that corresponds to a part where the molten resin is housed.

In Embodiment 2, potentiometers are used in place of the encoders 16f, 17f. Hereinafter, these potentiometers will be referred to as potentiometers 16f, 17f. The potentiometer 16f is means for detecting the position of the motor 16a (servomotor). The position of the first torpedo 14 can be detected based on a position detection value of the potentiometer 16f. Similarly, the potentiometer 17f is means for detecting the position of the motor 17a (servomotor). The position of the second torpedo 15 can be detected based on a position detection value of the potentiometer 17f. Further, a ceramic heater is used in place of the sheet heaters 62a. Hereinafter, this ceramic heater will be referred to as a ceramic heater 62a.

In Embodiment 2, a thermocouple is used as the temperature detection part 63 (means for detecting the temperature of the molten resin housed in the first cylinder 11 and the second cylinder 12).

Next, a control device 7A of Embodiment 2 will be described.

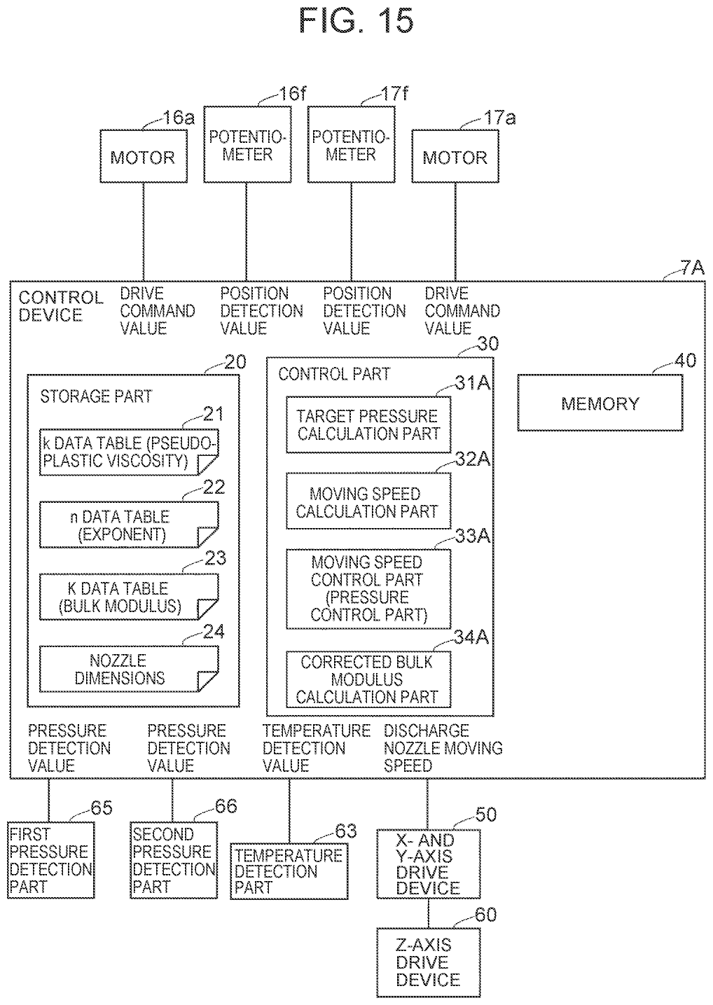

FIG. 15 is a configuration diagram of the control device 7A of Embodiment 2.

As shown in FIG. 15, the control device 7A includes a storage part 20, a control part 30A, and a memory 40.

The storage part 20 is, for example, a non-volatile storage part, such as a hard disk device or an ROM. The storage part 20 stores a k data table 21, an n data table 22, and a K data table 23. Further, the storage part 20 stores discharge nozzle dimensions 24 (e.g., a nozzle diameter, a nozzle length). The storage part 20 also stores predetermined programs (not shown) to be executed by the control part 30A.

The k data table 21 stores pseudoplastic viscosities k for respective types of resins and respective temperatures in advance. The pseudoplastic viscosity k will be described later. The n data table 22 stores exponents n for respective types of resins. The exponent n will be described later. The K data table 23 stores bulk moduli K for respective types of resins. The bulk modulus K will be described later.

The control part 30A includes a processor (not shown). The processor is, for example, a central processing unit (CPU). The control part 30A may have a single processor or may have multiple processors. The processor executes predetermined programs read from the storage part 20 onto the memory 40 (e.g., an RAM) to thereby function mainly as a target pressure calculation part 31A, a moving speed calculation part 32A, a moving speed control part 33A, and a corrected bulk modulus calculation part 34A. Some or all of these parts may be realized by hardware.

The motors 16a, 17a, the potentiometers 16f, 17f, the temperature detection part 63, the first pressure detection part 65, the second pressure detection part 66, an X- and Y-axis drive device 50, a Z-axis drive device 60, etc. are electrically connected to the control device 7A.

The X- and Y-axis drive device 50 drives the injection molding machine 2A (discharge nozzle 18a) along the X- and Y- axes by a mechanism (not shown). The Z-axis drive device 60 drives the baseplate 4 along the Z-axis by a mechanism (not shown).

The injection molding apparatus thus configured functions as a 3D printer (one example of the additive manufacturing apparatus of the present disclosure) that creates a three-dimensional shaped article (additively manufactured object) using molten resin discharged (injected) from the injection molding machine 2A (discharge nozzle 18a) that is driven along the X- and Y-axes by forming resin beads and sequentially layering them on the baseplate 4 that can be driven along the Z-axis.

Next, an outline of the operation of the injection molding machine 2A of Embodiment 2 will be described. The following process is realized by the control part 30A (processor) executing the predetermined programs read from the storage part 20 onto the memory 40 (e.g., the RAM).

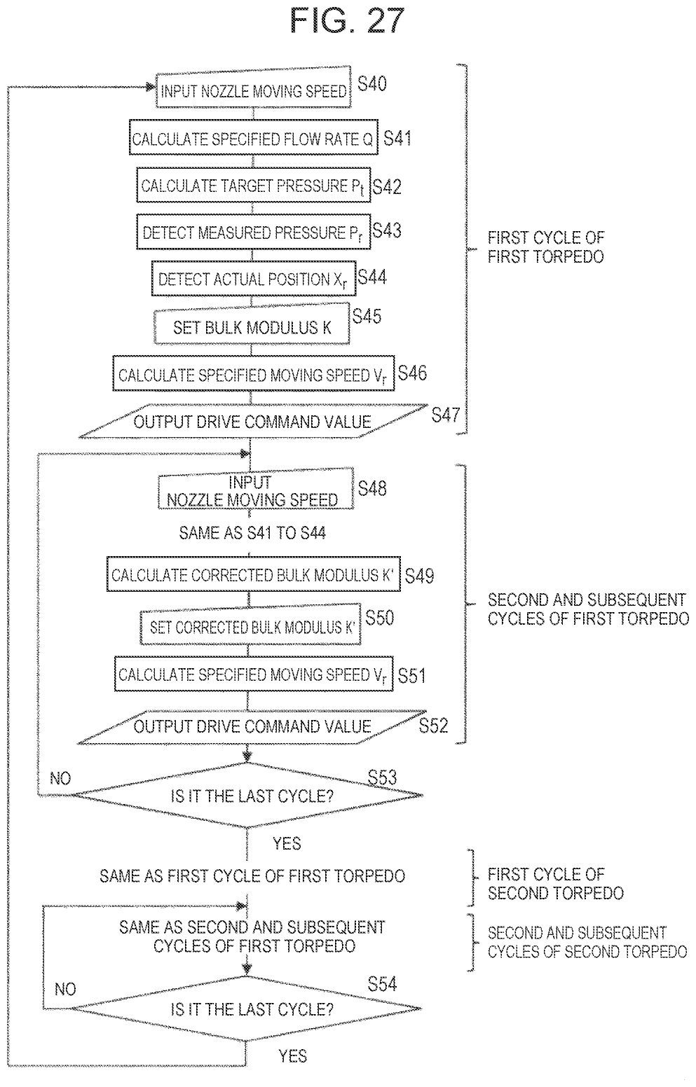

The baseplate 4 is disposed directly under a resin discharge hole of the discharge nozzle 18a, and the discharge nozzle 18a is moved by the X- and Y-axis drive device 50 in accordance with a shaping path for a first layer of the additively manufactured object. In this process, the moving speed of the discharge nozzle 18a is input into the control device 7A, and drive command values are output to the motors 16a, 17a in accordance with the flowchart of FIG. 27.

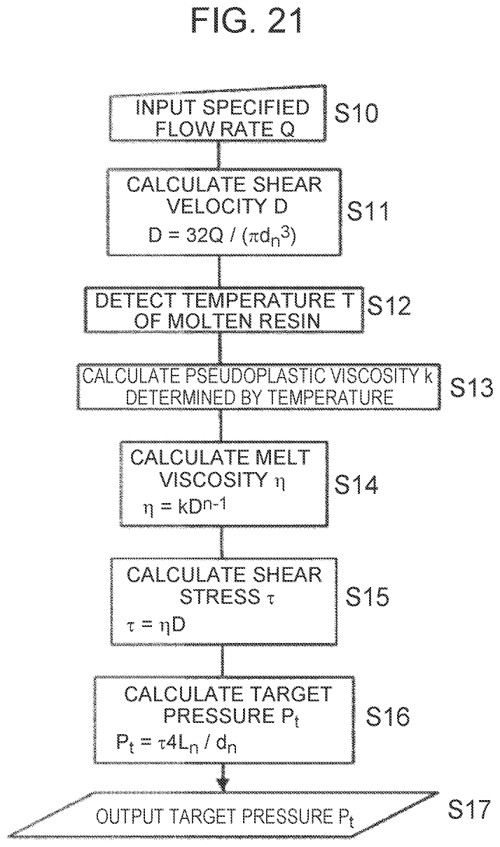

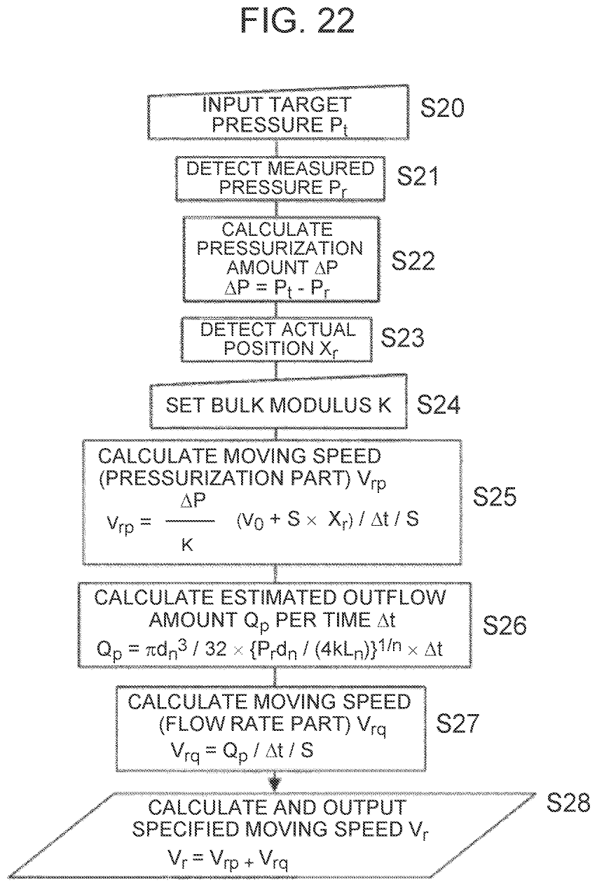

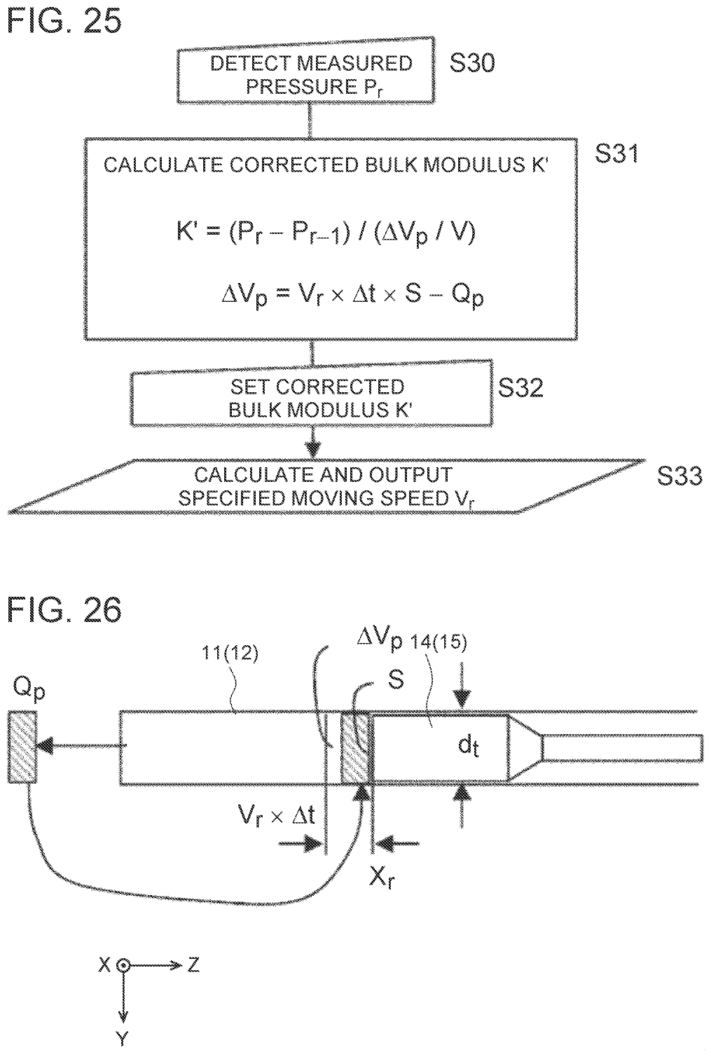

In accordance with the flowchart of FIG. 21, the control device 7A calculates a target pressure for achieving a specified flow rate from the position (position detection value), the pressure (pressure detection value), the temperature (temperature detection value), and the values (the pseudoplastic viscosity, the exponent, the bulk modulus, and the nozzle dimensions) stored in the storage part (data tables 21 to 23). In the first cycle, a specified moving speed is calculated and a drive command value based on this specified moving speed is output to the motor 16a or 17a in accordance with the flowchart of FIG. 22. In the second and subsequent cycles, a corrected bulk modulus K′ is calculated, a specified moving speed using this corrected bulk modulus K′ is calculated, and a drive command value based on this specified moving speed is output to the motor 16a or 17a in accordance with the flowchart of FIG. 25.

Definitions of Terms

The “specified flow rate” refers to a target value of the flow rate (target flow rate) of the molten resin discharged through the discharge nozzle 18a, and to a flow rate of the molten resin discharged through the nozzle 18a per unit time. A specified flow rate Q is represented by the following Expression 4:

Q=cross-sectional area of resin bead(=nozzle cross-sectional area)×nozzle moving speed (Expression 4)

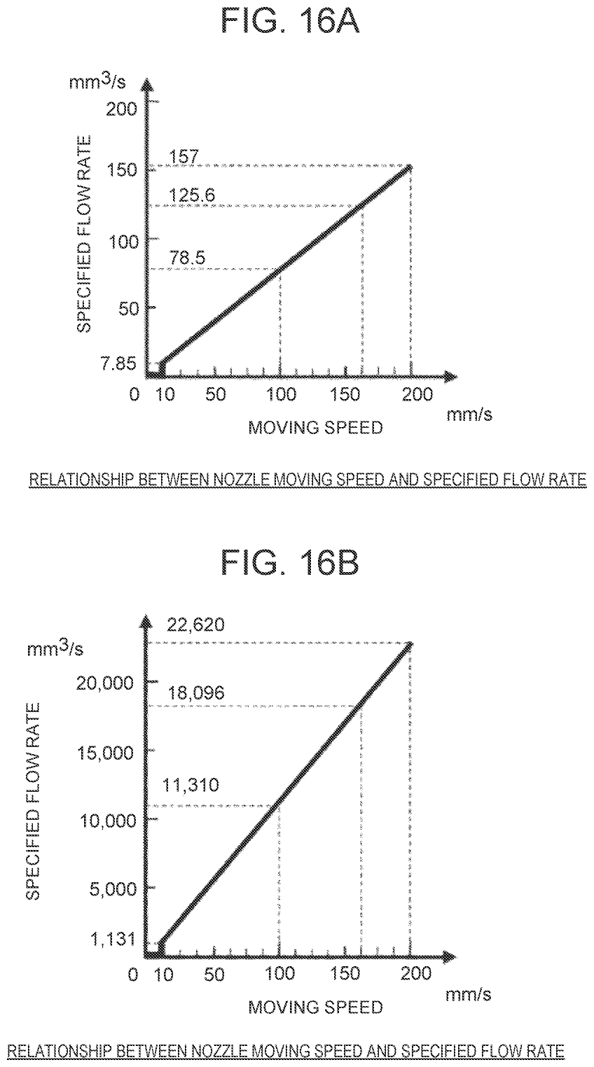

FIG. 16A is a graph showing a relationship between the nozzle moving speed and the specified flow rate (a case where the nozzle diameter is 1 mm and the cylinder diameter is 20 mm). In a region where the moving speed is close to zero, the specified flow rate may be set to zero when the flow rate is lower than a minimum control flow rate (7.85 in FIG. 16A). FIG. 16B is another graph showing a relationship between the nozzle moving speed and the specified flow rate (a case where the nozzle diameter is 12 mm and the cylinder diameter is 100 mm). In a region where the moving speed is close to zero, the specified flow rate may be set to zero when the flow rate is lower than a minimum control flow rate (1,131 in FIG. 16B).

The “exponent” refers to a constant that is determined for each resin.

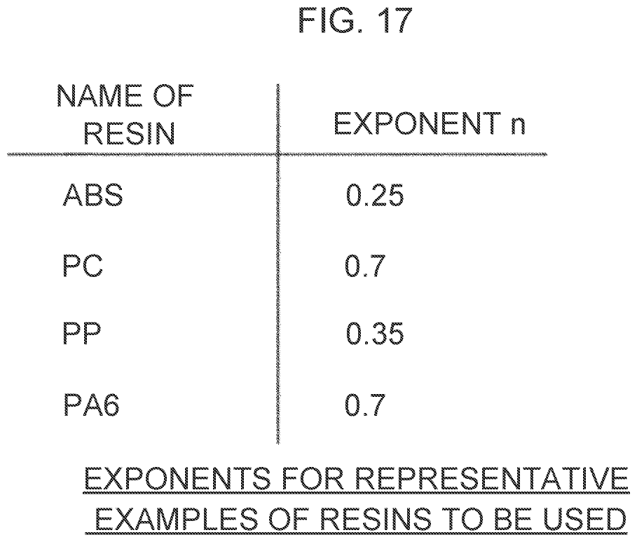

FIG. 17 is examples (representative examples) of exponents. The exponents to be used may be commonly known ones (e.g., see p. 9 of “Purasuchikku Seihin Sekkeihou” (“Plastic Products Design Method” (in Japanese)), by Seiichi Honma, Nikkan Kogyo Shimbun, Ltd., 2011).

The “pseudoplastic viscosity” is a constant that is determined for each resin according to the temperature. An example of obtaining the pseudoplastic viscosity will be described.

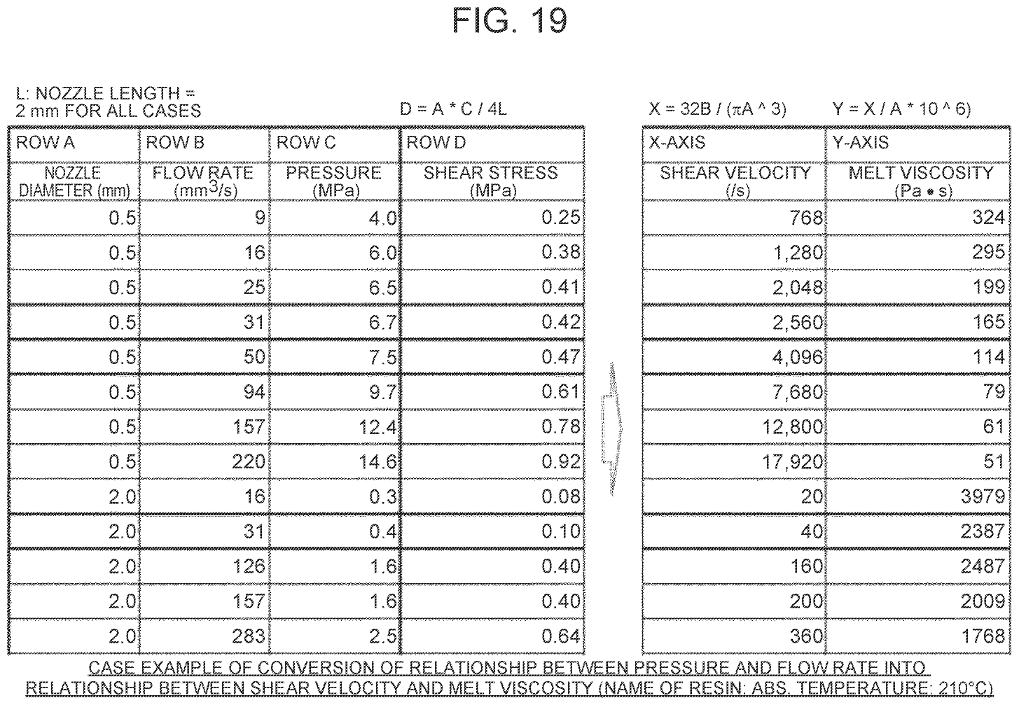

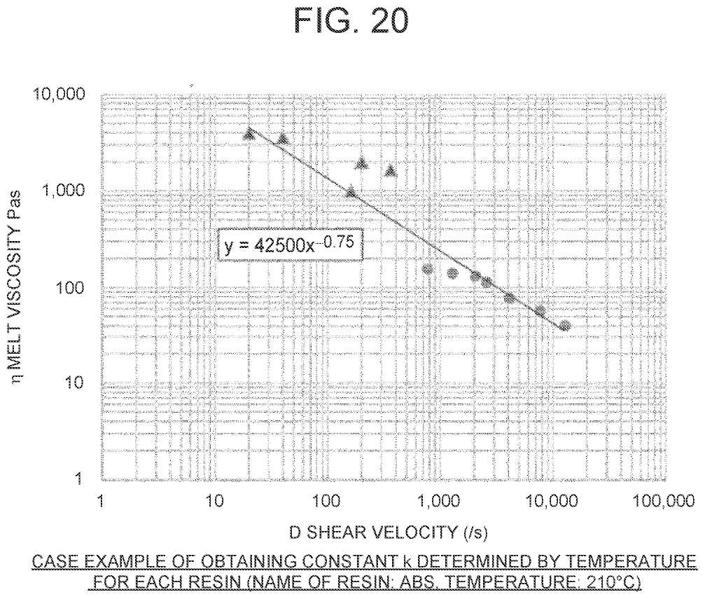

FIG. 19 is a specific example of conversion of a relationship between pressure and flow rate into a relationship between shear velocity and melt viscosity (name of resin: ABS, temperature: 210° C.). FIG. 20 is a graph on which the shear velocity and the melt viscosity of FIG. 19 are plotted.

From the experiment result of FIG. 19, the relationship between the measured pressure and flow rate is converted into the relationship between the shear velocity and the melt viscosity. These shear velocity and melt viscosity are plotted on the double logarithmic graph as shown in FIG. 20 and applied to a power approximation expression (y=kx(ⁿ⁻¹) by a least-square method to obtain y=42500×^{-0.75}. Thus, a pseudoplastic viscosity k=42,500 is obtained. The pseudoplastic viscosities of other resins at other temperatures than the resin ABS and the temperature 210° C. can be obtained in the same manner.

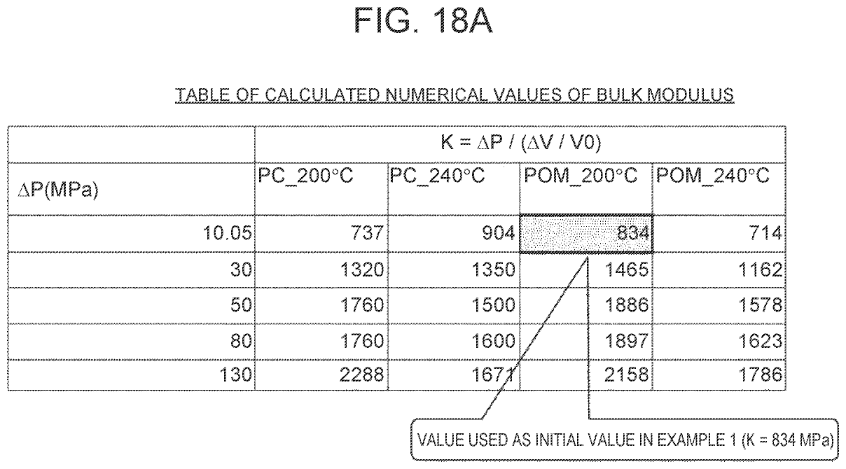

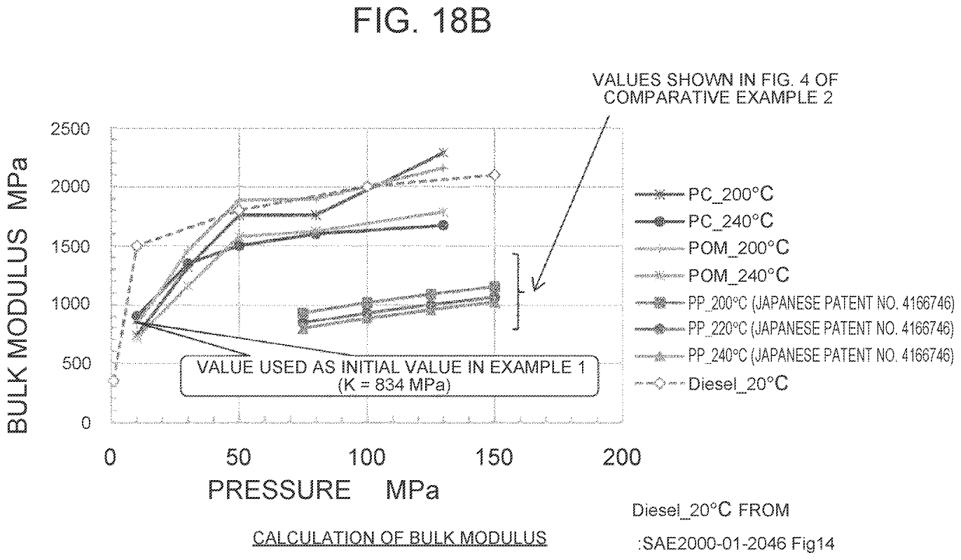

The “bulk modulus” refers to a constant that is determined by the characteristics of the molten resin. FIG. 18A is one example of a table of calculated numerical values of the bulk modulus, and FIG. 18B is a graph on which the values of FIG. 18A are plotted.

The “target pressure” refers to a pressure that is applied to the molten resin housed (stored) inside the cylinder 11 or 12 to make the flow rate of the molten resin discharged through the discharge nozzle 18a meet the specified flow rate.

The “estimated outflow amount” refers to an estimated outflow amount of molten resin discharged through the nozzle 18a per Δt (control time interval).

The “specified moving speed” refers to a speed with which the first piston unit 14 or the second piston unit 15 is moved to make the flow rate of the molten resin discharged through the nozzle 18a meet the specified flow rate. The first piston unit 14 or the second piston unit 15 is one example of the piston of the present disclosure. Hereinafter, the first piston unit 14 or the second piston unit 15 will also be referred to as a first torpedo 14 or a second torpedo 15. “Operating the injection molding machine” means discharging the resin (molten resin).

Example of Operation of Target Pressure Calculation Part 31A

Next, an example of the operation of the target pressure calculation part 31A will be described.

The target pressure calculation part 31A calculates the “target pressure” based on the specified flow rate, the temperature of the molten resin, the pseudoplastic viscosity, and the dimensions of the discharge nozzle 18a.

FIG. 21 is a flowchart of an example of the operation of the target pressure calculation part 31A.

First, the specified flow rate Q is input (acquired) (step S10).

Next, a shear velocity D relative to the specified flow rate Q is calculated by the following Expression 5 (step S11):

D=32Q/(πdₙ³) (Expression 5)

Here, dₙ is a diameter-equivalent value of a minimum cross-sectional area (nozzle diameter) of the discharge nozzle 18a. π is the ratio of the circumference of a circle to its diameter. The nozzle diameter dₙ can be acquired from the storage part.

Next, the temperature T of the molten resin immediately before being discharged is detected (step S12). The temperature T may be a temperature that is directly detected by the temperature detection part 63 (thermocouple) or may be an estimated temperature. Step S12 is one example of the temperature acquisition part of the present disclosure.

Next, the pseudoplastic viscosity k determined by the temperature T is calculated (step S13). The pseudoplastic viscosity k corresponding to the type and the temperature (the temperature T detected in step S12) of the resin (molten resin) can be acquired from the k data table 21. The type of resin (molten resin) is input by a user, for example. Step S13 is one example of the pseudoplastic viscosity acquisition part of the present disclosure.

Next, a melt viscosity 11 is calculated by the following Expression 6 (step S14):

η=kDⁿ⁻¹ (Expression 6)

Here, n is the exponent corresponding to the type of resin (molten resin). The exponent n corresponding to the type of resin (molten resin) can be acquired from the n data table 22. The type of resin (molten resin) is input by the user, for example.

Next, the shear stress τ is calculated by the following Expression 7 (step S15):

τ=ηD (Expression 7)

Next, a target pressure Pₜ is calculated by the following Expression 8 (step S16) and output (step S17). The target pressure Pₜ is a relative pressure based on the assumption that the pressure outside the discharge nozzle 18a is an atmospheric pressure (zero).

Pₜ=τ4Lₙ/dₙ (Expression 8)

Here, Lₙ, is the length (nozzle length) of the discharge nozzle 18a (diameter dₙ). The nozzle length Lₙ can be acquired from the storage part 20.

Example of Operation of Moving Speed Calculation Part 32A (Torpedo Moving Speed Feedforward Control)

Next, an example of the operation of the moving speed calculation part 32A (torpedo moving speed feedforward control) will be described.

The moving speed calculation part 32A calculates the “specified moving speed (for the first cycle of discharge).”

FIG. 22 is a flowchart of an example of the operation of the moving speed calculation part 32A (torpedo moving speed feedforward control).

First, the target pressure Pₜ calculated in step S16 and output in step S17 is input (acquired) (step S20).

Next, a measured pressure Pᵣ is detected (step S21). The measured pressure Pᵣ refers to a detection value (pressure detection value) of the first pressure detection part 65 or the second pressure detection part 66.

Next, a pressurization amount ΔP for achieving the target pressure Pₜ is calculated by the following Expression 9 (step S22):

ΔP=Pₜ−Pᵣ (Expression 9)

Next, a measured position Xᵣ is detected (step S23). The measured position Xᵣ refers to a detection value (position detection value) of the potentiometer 16f or 17f.

Next, the bulk modulus K corresponding to the type of resin (molten resin) is set (step S24). For example, in the first cycle of discharge, the bulk modulus K corresponding to the type of resin (molten resin) is acquired from the K data table 23. The type of resin (molten resin) is input by the user, for example.

Next, Vᵣₚ that is a pressurization part of the moving speed of the first torpedo 14 (or the second torpedo 15) is calculated by the following Expression 10 (step S25). The following Expression 10 does not take into account outflow (discharge) of the molten resin due to pressurization.

$$\begin{matrix}[ Expression 1 ] & \\ {V}_{rp} = \frac{Δ P}{K} ( {V}_{0} + S \times {X}_{r} ) / Δ t / S & ( Expression 10 )\end{matrix}$$

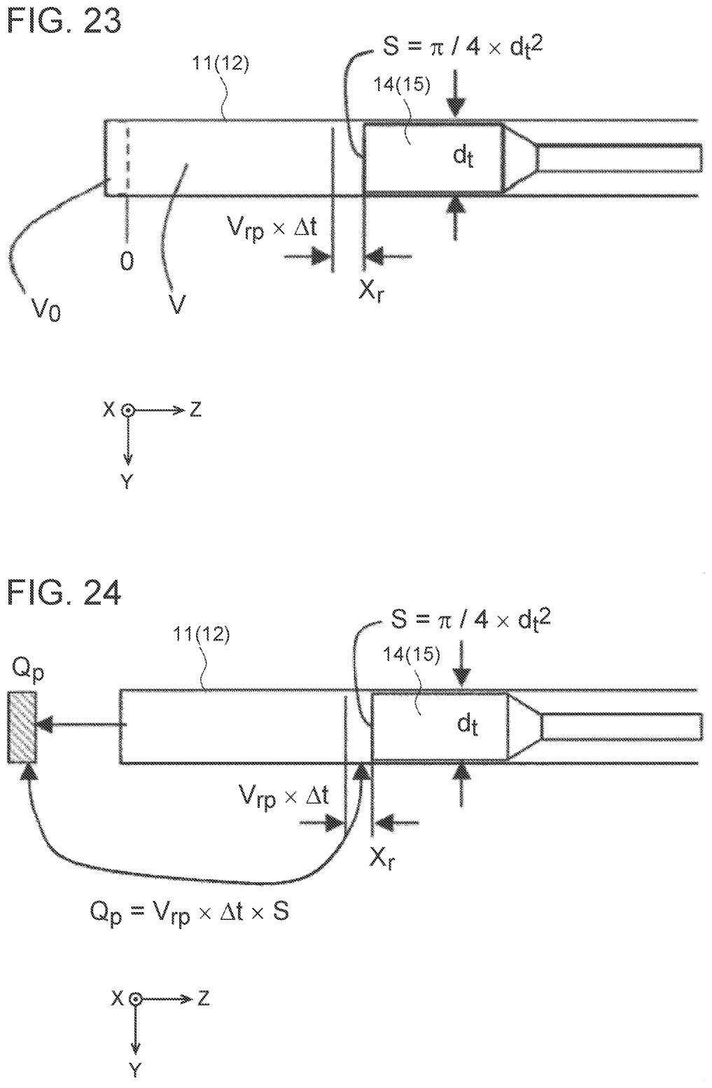

Here, ΔP=K×ΔV/V; ΔV=Vᵣₚ×Δt×S (S is the cross-sectional area of the first torpedo 14 (or the second torpedo 15), and Δt is the control time interval); V=V₀+S×Xᵣ (V is a volume pressurized when the first torpedo 14 (or the second torpedo 15) is located at Xᵣ), and V₀ is a dead volume); and S=π/4×dₜ (dₜ is the diameter of the first torpedo 14 (or the second torpedo 15)). These elements can be graphically represented as shown in FIG. 23. FIG. 23 is a schematic view showing the elements of Expression 10.

Next, an estimated outflow amount Qₚ is calculated by the following Expression 11 (step S26):

Qₚ=πdₙ³/32×{Pᵣdₙ (4kLₙ)}^{1/n}×Δt (Expression 11)

Expression 11 is derived as follows:

First, the above Expression 5 is transformed into the following Expression 12:

Qₚ=Dπdₙ³/32 (Expression 12)

Next, the above Expression 6 and Expression 7 are substituted into Expression 8 to obtain the following Expression 13:

Pᵣ=kD^{π}4Lₙ/dₙ (Expression 13)

This Expression 13 is transformed into the following Expression 14:

D=(Pᵣdₙ/4kLₙ)¹/n (Expression 14)

The above Expression 14 is substituted into the above Expression 12 to obtain the following Expression 15:

Qₚ=πdₙ³/32×{Pᵣdₙ/(4kLₙ)}¹/n (Expression 15)

The right side of this Expression 15 is multiplied by Δt to obtain the above Expression 11. The elements of Expression 12 to Expression 15 can be graphically represented as shown in FIG. 24. FIG. 24 is a schematic view showing the elements of Expression 12 to Expression 15.

Next, V_{rq} that is a flow rate part of the moving speed of the first torpedo 14 (or the second torpedo 15) is calculated by the following Expression 16 (step S27):

V_{rq}=Qₚ/Δt/S (Expression 16)

Next, a specified moving speed Vᵣ is calculated by adding up the pressurization part and the flow rate part by the following Expression 17, and the obtained specified moving speed Vᵣ is output (step S28):

Vᵣ=Vᵣₚ+V_{rq} (Expression 17)

Example of Operation of Second and Subsequent Cycles of Discharge (Method for Increasing Torpedo Moving Speed Estimation Accuracy)

Next an example of the operation of the second and subsequent cycles of discharge (a method for increasing torpedo moving speed estimation accuracy) will be described.

In the second and subsequent cycles of discharge, the moving speed calculation part 32A calculates the “specified moving speed (for the second and subsequent cycles of discharge).” In this process, a pressure change amount resulting from movement of the first torpedo 14 (or the second torpedo 15) is obtained from a measured pressure, and a volume change amount due to movement of the first torpedo 14 (or the second torpedo 15) is obtained. Using the measured pressure, a “real pressurization volume” is obtained by subtracting the outflow amount calculated by the above Expression 11 from this volume change amount. Then, a corrected bulk modulus is obtained from the pressure change amount and the “real pressurization volume,” and the obtained corrected bulk modulus is used for calculation of the specified moving speed (see steps S32 and S33 to be described later). In this way, an estimated value (corrected bulk modulus) reflecting the bulk modulus according to the degree of inclusion of air into the molten resin can be used, and the accuracy is thereby increased.

FIG. 25 is a flowchart of an example of the operation of the second and subsequent cycles of discharge.

First, the measured pressures Pᵣ is detected (step S30). The measured pressure Pᵣ refers to a detection value (pressure detection value) of the first pressure detection part 65 or the second pressure detection part 66.

Next, the corrected bulk modulus calculation part 34A calculates the corrected bulk modulus K′ by the following Expression 18 (step S31):

K′=(Pᵣ−Pᵣ₋₁)/(ΔVₚ/V) (Expression 18).

Here, Pᵣ is a measured pressure for calculating the corrected bulk modulus with the control time interval being Δt. Pᵣ₋₁ is the measured pressure of Δt time ago. ΔVₚ is obtained by subtracting the outflow amount from a volume of decrease due to movement of the first torpedo 14 (or the second torpedo 15) in the time Δt, and is the “real pressurization volume.”

ΔVₚ is calculated by the following Expression 19:

ΔVₚ=Vᵣ×Δt×S−Qₚ (Expression 19)

Elements of Expression 18 and Expression 19 can be graphically represented as shown in FIG. 26. FIG. 26 is a schematic view showing the elements of Expression 18 and Expression 19.

Next, the moving speed calculation part 32A sets the corrected bulk modulus K′ as the bulk modulus K′ for the second cycle (step S32).

Next, the moving speed calculation part 32A calculates and outputs the specified moving speed Vᵣ in the same manner as in the first cycle (step S25 to S28) (step S33).

Example of Operation of Moving Speed Control Part 33A

The moving speed control part 33A controls the motor 16a or 17a such that the moving speed of the first torpedo 14 (or the second torpedo 15) meets the specified moving speed Vᵣ calculated and output in step S28 (in the first cycle of discharge). Specifically, the moving speed control part 33A outputs a drive command value to the motor 16a or 17a such that the moving speed of the first torpedo 14 (or the second torpedo 15) meets the specified moving speed Vᵣ. Further, the moving speed control part 33A controls the motor 16a or 17a such that the moving speed of the first torpedo 14 (or the second torpedo 15) meets the specified moving speed Vᵣ calculated and output in step S33 (in the second and subsequent cycles of discharge). Specifically, the moving speed control part 33A outputs a drive command value to the motor 16a or 17a such that the moving speed of the first torpedo 14 (or the second torpedo 15) meets the specified moving speed Vᵣ.

Example 1 of Flow Rate Control

Next, Example 1 of flow rate control will be described.

Example 1 is an example of discharge control in which a small-sized object is printed at high resolution. In Example 1, flow rate control and a control method of the nozzle 18a will be described in a case where the nozzle diameter is as small as ϕ1 mm (cylinder diameter dₜ=20 mm) and the nozzle 18a having the nozzle diameter of ϕ1 mm is driven at a moving speed of 160 mm/s that is a normal speed (a maximum speed normally used) to form ABS resin beads with a ϕ1 mm circular cross-section in a straight line.

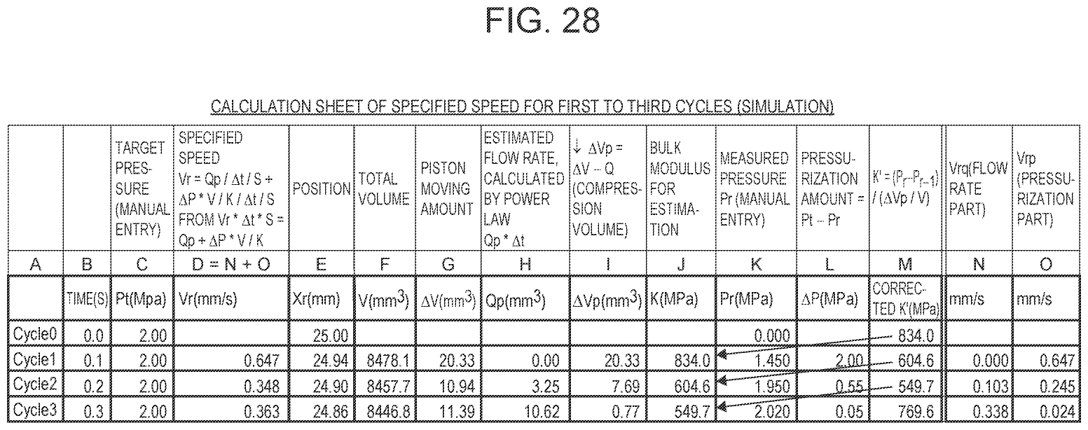

FIG. 27 is a flowchart common to Example 1 and Example 2 of the flow rate control. FIG. 28 is a table summarizing simulation results (the first to third cycles) of Example 1.

The following description is based on the assumption that the molten resin is continuously discharged through the discharge nozzle 18a as the first torpedo 14 and the second torpedo 15 alternately pressurize the molten resin inside the cylinders 11, 12 (see FIG. 9 to FIG. 13).

Each cycle in FIG. 27 corresponds to Δt (control time interval).

First, the process of the first cycle of the first torpedo 14 (steps S40 to S47) will be described.

First, the nozzle moving speed is input (step S40). Here, it is assumed that that the moving speed of the nozzle 18a is 160 mm/s has been detected from the X-and Y-axis drive device 50 and that this moving speed has been input into the control device 7A.

Next, the specified flow rate Q is calculated (step S41). Here, it is assumed that the specified flow rate Q has been calculated by the above Expression 4 as follows: Specified flow rate Q=cross-sectional area of resin bead (=cross-sectional area of nozzle 18a)×nozzle moving speed=π/4×1 mm²×160 mm/s=125.6 mm³/s.

Next, the target pressure Pₜ is calculated (step S42). Specifically, the process (steps S11 to S17) shown in FIG. 21 is executed.

First, the shear velocity D is calculated (step S11). Here, it is assumed that the shear velocity D has been calculated by the above Expression 5 as follows: Shear velocity D=32Q/(πdₙ³)=32×125.6 mm³/s/(3.14×(1 mm)³)=1,280/s. Here, Q=125.6 mm³/s and dₙ=1 mm.

Next, the temperature T of the molten resin immediately before being discharged is detected (step S12). Here, it is assumed that the temperature T=210° C. has been detected.

Next, the pseudoplastic viscosity k determined by the temperature T is calculated (step S13). Here, it is assumed that the pseudoplastic viscosity k of an ABS resin at 210° C. has been calculated as 42,500 [kg/(m s²⁻ⁿ)] (see FIG. 20).

Next, the melt viscosity η is calculated (step S14). Here, it is assumed that the melt viscosity η has been calculated by the above Expression 6 as follows: Melt viscosity η=kDⁿ⁻¹=42,500 kg/(m·s^{2-0.25})×1,280^{0.25-1}/s^{0.25-1}=199 kg/(m s)=199 Pa·s. In the case of the ABS resin, n=0.25 (see FIG. 17).

Next, the shear stress ti is calculated (step S15). Here, it is assumed that the shear stress τ has been calculated by the above Expression 7 as follows: Shear stress τ=ηD=199 Pa·s×1,280/s=254,720 Pa=0.25 MPa. Here, =199 Pa·s and D=1,280/s.

Next, the target pressure Pₜ is calculated (step S16). Here, it is assumed that the target pressure Pₜ has been calculated by the above Expression 8 as follows: Target pressure Pₜ=τ4 L/dₙ=0.25 MPa×4×2 mm/1 mm=2.0 MPa. Here, τ=0.25 MPa, L=2 mm, and dₙ=1 mm. This target pressure Pₜ (2.0 MPa) is output to the control device 7A (step S17).

Next, referring to FIG. 27 again, the measured pressure Pᵣ is detected (step S43). Here, it is assumed that the measured pressure Pᵣ=0.0 MPa has been detected.

Next, the pressurization amount ΔP is calculated. Here, it is assumed that the pressurization amount ΔP has been calculated by the above Expression 9 as follows: Pressurization amount ΔP=Pₜ−Pᵣ=2.0 MPa−0.0 MPa=2.0 MPa.

Next, the actual position Xᵣ is detected (step S44). Here, it is assumed that the actual position Xᵣ=25 mm has been detected.

Next, the bulk modulus K is set (step S45). Here, it is assumed that the bulk modulus K=834 MPa has been set (see FIG. 18A).

Next, the specified moving speed Vᵣ is calculated (step S46). Specifically, the process (steps S25 to S28) shown in FIG. 22 is executed.

First, the moving speed Vᵣₚ (pressurization part) of the first torpedo 14 is calculated (step S25). Here, it is assumed that the moving speed (pressurization part) Vᵣₚ has been calculated by the above Expression 10 as follows: Moving speed (pressurization part) Vᵣₚ=(2.0 MPa/834 MPa) (628 mm³+314 mm²×25 mm)/0.1 s/314 mm²=0.647 mm/s. Here, V₀=628 mm³, S=π/4×dₜ=314 mm² (dₜ=20 mm), and Δt=0.1 sec. Δt is not limited to 0.1 sec but may have a different value.

Next, the estimated outflow amount Qₚ is calculated (step S26). Here, it is assumed that the estimated outflow amount Qₚ has been calculated by the above Expression 11 as follows: Estimated outflow amount Qₚ=πdₙ³/32×{Pᵣdₙ/(4kLₙ}^{1/n}×Δt=0 mm³. Here, Pᵣ=0.0 MPa.

Next, the moving speed (flow rate part) V_{rq} of the first torpedo 14 is calculated (step S27). Here, it is assumed that the moving speed (flow rate part) V_{rq}, has been calculated by the above Expression 16 as follows: Moving speed (flow rate part) V_{rq}=Qₚ/Δt/s=0 mm/s. Here, Qₚ 0 mm³.

Next, the specified moving speed Vᵣ is calculated and output (step S28). Here, it is assumed that the specified moving speed Vᵣ has been calculated by the above Expression 17 as follows and output: Specified moving speed Vᵣ=Vᵣₚ V_{rq}=0.647 mm/s+0 mm/s=0.647 mm/s.

Next, a drive command value is output to the motor 16a such that the moving speed of the first torpedo 14 meets the specified moving speed Vᵣ calculated in step S46 (step S27) (step S47).

Next, the process of the second and subsequent cycles of the first torpedo 14 (torpedo moving speed feedback control, steps S48 to S52) will be described.

First, the nozzle moving speed is input (step S48). Here, it is assumed that that the moving speed of the nozzle 18a is 160 mm/s has been detected from the X-and Y-axis drive device and this moving speed has been input into the control device 7A.

Next, the same process as in steps S41 to S44 is executed.

Here, it is assumed that a measured pressure Pᵣ=1.45 MPa has been detected in step S43.

Next, the corrected bulk modulus K′ is calculated (step S49). Here, it is assumed that the corrected bulk modulus K′ has been calculated by the above Expression 18 as follows: Corrected bulk modulus K′=(Pᵣ−Pᵣ₋₁)/(ΔV_{P}/V) ΔV_{P}=Vᵣ×Δt×S−Qₚ=(1.45 MPa−0 MPa)/(20.33 mm³/8,478 mm³)=604.6 MPa. Here, ΔV_{P}=0.647 mm/s×0.1 s×314 mm²−0 mm³=20.33 mm³, Pᵣ=1.45 MPa, Pᵣ₋₁=0 MPa, V=628 mm³+π/4×202 mm²×25 mm=8,478 mm³.

Next, the corrected bulk modulus K′ is set as the bulk modulus K′ for the second cycle (step S50).

Next, the specified moving speed Vᵣ is calculated in the same manner as in the first cycle (step S46) (step S51). Here, it is assumed that the specified moving speed Vᵣ has been calculated by the above Expression 17 as follows: Specified moving speed Vᵣ=Vᵣₚ+V_{rq}=0.245 mm/s+0.103 mm/s=0.348 mm/s. Here, ΔP=Pₜ−Pᵣ=2.0 MPa−1.45 MPa=0.55 MPa, Xr=24.94 mm, Vᵣₚ=(0.55 MPa/604.6 MPa) (628 mm³+314 mm²×24.94 mm)/0.1 s/314 mm²=0.245 mm/s, Qₚ=π×(1 mm)³/32×{1.45 MPa×1 mm/(4×42,500 kg/(m·s^{2-0.25})×2 mm)}^{1/0.25}×0.1 s=3.25 mm³, and V_{rq}=3.25 mm³/0.1 s/314 mm²=0.103 mm/s.

Next, a drive command value is output to the motor 16a such that the moving speed of the first torpedo 14 meets the specified moving speed Vᵣ calculated in step S51 (step S52).

Also in the second and subsequent cycles, steps S48 to S52 are repeatedly executed until the cycle is determined to be the last one (step S53: YES), i.e., until it is determined that the first torpedo 14 has reached the bottom dead center. Whether the first torpedo 14 has reached the bottom dead center can be determined based on a detection value (position detection value) of the potentiometer 16f.

Next, the same process as in steps S40 to S52 is executed until the second torpedo 15 moves toward the Z-axis plus side and reaches the farthest point on the Z-axis minus side (bottom dead center) (step S54: YES).

Example 2 of Flow Rate Control

Next, Example 2 of the flow rate control will be described.

Example 2 is an example of discharge control in which a large object the size of an automobile is printed in a short time. In Example 2, flow rate control and a control method of the nozzle 18a will be described in a case where the nozzle diameter is as large as ϕ12 mm (cylinder diameter dₜ=100 mm) and the nozzle 18a having the nozzle diameter of ϕ12 mm is driven at a moving speed of 160 mm/s that is a normal speed (a maximum speed normally used) to form ABS resin beads with a ϕ12 mm circular cross-section in a straight line.

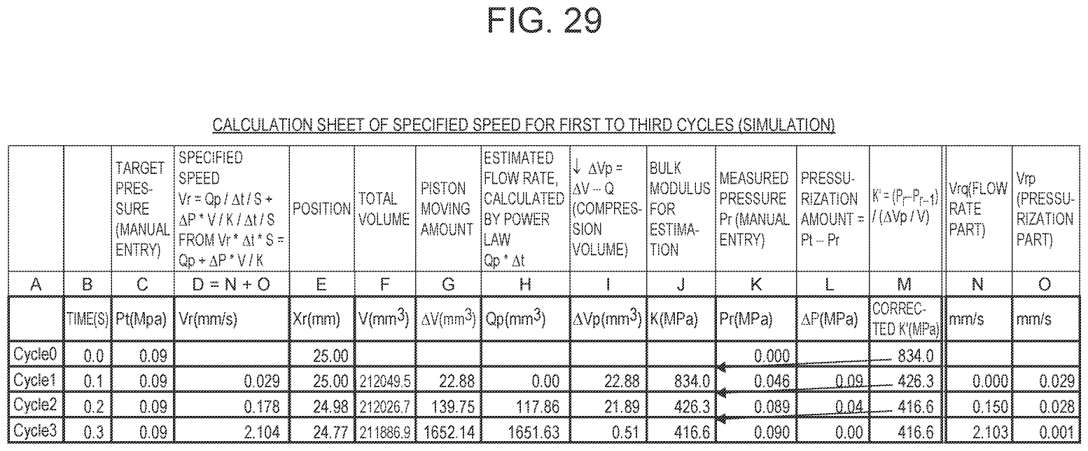

FIG. 27 is a flowchart common to Example 1 and Example 2 of the flow rate control. FIG. 29 is a table summarizing simulation results (the first to third cycles) of Example 2.

The following description is based on the assumption that the molten resin is continuously discharged through the discharge nozzle 18a as the first torpedo 14 and the second torpedo 15 alternately pressurize the molten resin inside the cylinders 11, 12 (see FIG. 9 to FIG. 13).

Each cycle in FIG. 27 corresponds to Δt (control time interval).

First, the process of the first cycle of the first torpedo 14 (steps S40 to S47) will be described.

First, the nozzle moving speed is input (step S40). Here, it is assumed that that the moving speed of the nozzle 18a is 160 mm/s has been detected from the X-and Y-axis drive device 50 and this moving speed has been input into the control device 7A.

Next, the specified flow rate Q is calculated (step S41). Here, it is assumed that the specified flow rate Q has been calculated by the above Expression 4 as follows: Specified flow rate Q=cross-sectional area of resin bead (=cross-sectional area of nozzle 18a)× nozzle moving speed=π/4×122 mm²×160 mm/s=18,096 mm³/s.

Next, the target pressure Pₜ is calculated (step S42). Specifically, the process (steps S11 to S17) shown in FIG. 21 is executed.

First, the shear velocity D is calculated (step S11). Here, it is assumed that the shear velocity D has been calculated by the above Expression 5 as follows: Shear velocity D=32×18,096 mm³/s/(3.14×(12 mm)³)=106.7/s. Here, Q=18,096 mm³/s and dₙ=12 mm.

Next, the temperature T of the molten resin immediately before being discharged is detected (step S12). Here, it is assumed that the temperature T=210° C. has been detected.

Next, the pseudoplastic viscosity k determined by the temperature T is calculated (step S13). Here, it is assumed that the pseudoplastic viscosity k of an ABS resin at 210° C. has been calculated as 42,500 [kg/(m·s²⁻ⁿ)] (see FIG. 20).

Next, the melt viscosity η is calculated (step S14). Here, it is assumed that the melt viscosity η has been calculated by the above Expression 6 as follows: Melt viscosity η=42,500 kg/(m·s^{2-0.25})×106.7^{0.25-1}/s^{0.25-1} 1,280 kg/(m·s)=1,280 Pa·s. In the case of the ABS resin, n=0.25 (see FIG. 17).

Next, the shear stress τ is calculated (step S15). Here, it is assumed that the shear stress τ has been calculated by the above Expression 7 as follows: Shear stress τ=1,280 Pa·s×106.7/s=136,576 Pa=0.14 MPa. Here, η=1,280 Pa·s and D=106.7/s.

Next, the target pressure Pₜ is calculated (step S16). Here, it is assumed that the target pressure Pₜ has been calculated by the above Expression 8 as follows: Target pressure Pₜ=0.14 MPa×4×2 mm/12 mm=0.09 MPa. Here, τ=0.14 MPa, L=2 mm, and dₙ=12 mm. This target pressure Pₜ (0.09 MPa) is output to the control device 7A (step S17).

Nest, referring to FIG. 27 again, the measured pressure Pᵣ is detected (step S43). Here, it is assumed that the measured pressure Pᵣ=0.0 MPa has been detected.

Next, the pressurization amount ΔP is calculated. Here, it is assumed that the pressurization amount ΔP has been calculated by the above Expression 9 as follows:

Pressurization amount ΔP=Pₜ−Pᵣ=0.09 MPa−0.0 MPa=0.09 MPa.

Next, the actual position Xᵣ is detected (step S44). Here, it is assumed that the actual position Xᵣ=25 mm has been detected.

Next, the bulk modulus K is set (step S45). Here, it is assumed that the bulk modulus K=834 MPa has been set (see FIG. 18A).

Next, the specified moving speed Vᵣ is calculated (step S46). Specifically, the process (steps S25 to S28) shown in FIG. 22 is executed.

First, the moving speed (pressurization part) Vᵣₚ of the first torpedo 14 is calculated (step S25). Here, it is assumed that the moving speed (pressurization part) Vᵣₚ has been calculated by the above Expression 10 as follows: Moving speed (pressurization part) Vᵣₚ=(0.09 MPa/834 MPa) (15,700 mm³+7,854 mm²×25 mm)/0.1 s/7,854 mm²=0.029 mm/s. Here, V₀=15,700 mm³, S=7,854 mm² (dₜ=100 mm), and Δt=0.1 sec. Δt is not limited to 0.1 sec but may have a different value.

Next, the estimated outflow amount Qₚ is calculated (step S26). Here, it is assumed that the estimated outflow amount Qₚ has been calculated by the above Expression 11 as follows: Estimated outflow amount Qₚ=πdₙ³/32×{Pᵣdₙ/(4kLₙ)}^{1/n}×Δt=0 mm³. Here, Pᵣ=0.0 MPa.

Next, the moving speed (flow rate part) V_{rq} of the first torpedo 14 is calculated (step S27). Here, it is assumed that the moving speed (flow rate part) V_{rq} has been calculated by the above Expression 16 as follows: Moving speed (flow rate part) V_{rq}=Qₚ/Δt/s=0 mm/s. Here, Qₚ=0 mm³.

Next, the specified moving speed Vᵣ is calculated and output (step S28). Here, it is assumed that the specified moving speed Vᵣ has been calculated by the above Expression 17 as follows and output: Specified moving speed Vᵣ=Vᵣₚ+V_{rq}=0.029 mm/s+0 mm/s=0.029 mm/s.

Next, a drive command value is output to the motor 16a such that the moving speed of the first torpedo 14 meets the specified moving speed Vᵣ calculated in step S46 (step S27) (step S47).

Next, the process of the second and subsequent cycles of the first torpedo 14 (torpedo moving speed feedback control, steps S48 to S52) will be described.

First, the nozzle moving speed is input (step S48). Here, it is assumed that that the moving speed of the nozzle 18a is 160 mm/s has been detected from the X-and Y-axis drive device and that this moving speed has been input into the control device.

Next, the same process as in steps S41 to S44 is executed.

Here, it is assumed that the measured pressure Pᵣ=0.046 MPa has been detected in step S43.

Next, the corrected bulk modulus K′ is calculated (step S49). Here, it is assumed that the corrected bulk modulus K′ has been calculated by the above Expression 18 as follows: Corrected bulk modulus K′=(Pᵣ−Pᵣ₋₁)/(ΔVₚ/V) ΔVₚ=Vᵣ×Δt×S−Qₚ=(0.046 MPa−0 MPa)/(22.88 mm³/212,049 mm³)=426.3 MPa. Here, ΔVₚ=0.029 mm/s×0.1 s×7,854 mm²−0 mm³=22.88 mm³, Pᵣ=0.046 MPa, Pᵣ₋₁=0 MPa, and V=15,700 mm³+π/4×1002 mm²×25 mm=212,049 mm³.

Next, the corrected bulk modulus K′ is set as the bulk modulus K′ for the second cycle (step S50).

Next, the specified moving speed Vᵣ is calculated in the same manner as in the first cycle (step S46) (step S51). Here, it is assumed that the specified moving speed Vᵣ has been calculated by the above Expression 17 as follows: Specified moving speed Vᵣ=Vᵣₚ+V_{rq}=0.028 mm/s+0.150 mm/s=0.178 mm/s. Here, ΔP=Pₜ−Pᵣ=0.09 MPa−0.046 MPa=0.044 MPa, Xᵣ=24.98 mm, Vᵣₚ=(0.044 MPa/426.3 MPa) (15,700 mm³+7,854 mm²×24.98 mm)/0.1 s/7,854 mm²=0.028 mm/s, Qₚ=π×(12 mm)³/32×{0.046 MPa×12 mm/(4×42,500 kg/(m·s^{2-0.25})×2 mm)}^{1/0.25}×0.1 s=117.86 mm³, and V_{rq}=117.86 mm³/0.1 S/7,854 mm²=0.150 mm/s.

Next, a drive command value is output to the motor 16a such that the moving speed of the first torpedo 14 meets the specified moving speed Vᵣ calculated in step S51 (step S52).

Also in the second and subsequent cycles, steps S48 to S52 are repeatedly executed until the cycle is determined to be the last one (step S53: YES), i.e., until it is determined that the first torpedo 14 has reached the bottom dead center. Whether the first torpedo 14 has reached the bottom dead center can be determined based on a detection value (position detection value) of the potentiometer 16f.

Next, the same process as in steps S40 to S52 is executed until the second torpedo 15 moves toward the Z-axis plus side and reaches the farthest point on the Z-axis minus side (bottom dead center) (step S54: YES).

As has been described above, Embodiment 2 can provide an injection molding machine capable of optimally controlling the discharge amount while in operation.

This is made possible by including the moving speed control part 33A that controls the moving speed of the piston so as to meet the specified moving speed (the specified moving speed that is the sum of the pressurization part of the moving speed of the piston (the first torpedo 14 or the second torpedo 15) at which the pressure applied to the molten resin inside the cylinder meets the target pressure, and the flow rate part of the moving speed of the piston at which the flow rate of the molten resin discharged through the discharge nozzle 18a per unit time meets the estimated outflow amount).

According to Embodiment 2, the estimated outflow amount and the target moving speed of the piston (the first torpedo 14 or the second torpedo 15) are calculated from the measured pressure, so that the discharge flow rate can be controlled without the actual outflow amount being measured. Therefore, the discharge flow rate can be controlled while the injection molding machine 2A is kept in operation.

According to Embodiment 2, in a cycle at the start of discharge (e.g., the first cycle of the first torpedo in FIG. 27), the bulk modulus that is stored in advance is used, so that the target specified flow rate can be quickly achieved.

According to Embodiment 2, the flow rate can be set with high accuracy according to the degree of inclusion of air into the molten resin.

According to Embodiment 2, the target pressure can be calculated and the discharge flow rate can be controlled by taking into account the type of resin (material type) of molten resin, the temperature thereof, and the nozzle dimensions.

This is made possible by including the moving speed control part (one example of the pressure control part of the present disclosure) that controls the pressure of the molten resin inside the cylinder so as to meet the target pressure.

According to Embodiment 2, the target pressure of the molten resin is calculated using the pseudoplastic viscosity that varies with the temperature, so that the resin discharge flow rate can be correctly controlled.

According to Embodiment 2, even when multiple types of resin materials are used, the resin discharge flow rate can be correctly controlled by calculating the target pressure of the molten resin using a different pseudoplastic viscosity according to the type of resin material.

According to Embodiment 2, the pseudoplastic viscosities for respective types of resin used and respective temperatures are stored in advance, which can reduce the arithmetic processing load of calculating the target pressure. Further, the target specified flow rate can be quickly achieved already in a cycle at the start of discharge.

According to Embodiment 2, the moving speed control part 33A performs feedforward control on the moving speed of the piston (the first torpedo 14 or the second torpedo 15) using the bulk modulus of the molten resin, and can thereby control the pressure to the target pressure more correctly.

According to Embodiment 2, the estimated outflow amount and the specified moving speed of the piston (the first torpedo 14 or the second torpedo 15) are calculated from the measured pressure, so that the discharge flow rate can be controlled without the actual outflow amount being measured. Therefore, the discharge flow rate can be controlled while the injection molding machine is kept in operation.

According to Embodiment 2, the corrected bulk modulus calculation part 34A that corrects the bulk modulus based on the pressure change amount calculated from the measured pressure and the real pressurization volume is included. Therefore, the flow rate can be set with high accuracy according to the degree of inclusion of air into the molten resin.

According to Embodiment 2, the corrected bulk modulus calculation part 34A corrects the bulk modulus only when the difference between the measured pressure and the target pressure is equal to or larger than a predetermined value. Thus, the value of the bulk modulus can be corrected only when necessary.

Embodiment 2 further has the following effects.

It is desirable that the flow rate control of the resin discharge nozzle 18a described in Embodiment 2 be applied to a 3D printer that forms and layers resin beads (molten resin having been discharged through the nozzle 18a and solidified into a thread-like form) using a resin pellet material (that is a common form of resin industrially available in large quantities and therefore significantly more inexpensive than filaments used for conventional 3D printers, such as those produced by Stratasys Ltd.).

The reason is that Embodiment 2 has the potential to solve the following four challenges.

<Challenge 1> A 3D printer (the injection molding machine 2A or the injection molding apparatus 1 including the injection molding machine 2A) is required to be able to form resin beads of uniform thickness even when the moving speed of the nozzle 18a changes. That is, it is required to detect the moving speed and quickly adapt the flow rate to that moving speed.

<Challenge 2> With the resin nozzle assumed in the present disclosure, it is difficult to measure the actual flow rate in the resin discharge nozzle while running the 3D printer. Therefore, a control method based on a measured value of the resin discharge pressure is commonly adopted.

<Challenge 3> However, the present inventor has found that, depending on the type of resin material, the temperature of molten resin, and the diameter of the discharge hole, the actual flow rate varies considerably even at the same pressure. At high temperatures, the melt viscosity becomes low and therefore the flow rate tends to become high relatively to the pressure. Further, when the nozzle diameter is larger, the extent of the influence of wall surface friction is smaller, so that the apparent viscosity decreases and the flow rate tends to become high relatively to the pressure. Being a non-Newtonian fluid, molten resin has lower apparent viscosity and a higher flow rate at a higher flow rate. It is desirable that a single 3D printer can handle various types of resins, various temperatures of molten resin, and various diameters of the discharge hole from an extremely small diameter (e.g., ϕ0.5 mm) to a large diameter (e.g., ϕ12 mm). (For example, when creating a small object, such as a pen case, and creating a large object, such as a minivan, are compared, the time taken to form one layer in additive manufacturing is different, which makes it necessary to change the resin temperature and the nozzle diameter according to the amount of heat dissipated before the next layer is deposited, etc.)

<Challenge 4> The present inventor has made the following discovery: The plasticization process differs in each stroke depending on the degree of filling of pellets and other factors, which is a challenge in using a resin pellet material. As a result, even when the compression volume is the same, the actual pressure rise differs depending on the state of melting (the degree of inclusion of air) (this difference is attributable to the difference in the bulk modulus), and consequently the flow rate also differs.

To solve these Challenges 1 to 4, in Embodiment 2, material physical property values corresponding to various resins types and various molten resin temperatures are stored as constants in the data tables 21 to 23 in advance. The type of resin to be charged is input and the temperature of the molten resin is measured. Then, the constants corresponding to these type and temperature, and the diameter of the discharge hole of the nozzle mounted (nozzle diameter) are input, and the target pressure for discharging the molten resin at the specified flow rate calculated from the moving speed is thereby calculated. Thus, Challenges 1 and 3 are solved.

Next, to achieve this target pressure, control is performed using the moving speed that is the sum of the moving speed of the torpedo (the first torpedo 14 or the second torpedo 15) at which the amount of pressurization calculated from the difference from the measured pressure occurs and the moving speed of the torpedo that corresponds to the outflow amount during movement of the torpedo. Since the outflow amount is difficult to directly measure, a flow rate estimated from the measured pressure is used. When calculating the moving speed of the torpedo at which the amount of pressurization occurs, in a cycle at the start of discharge (e.g., the first cycle of the first torpedo in FIG. 27), the corresponding bulk modulus in the data table is used to perform feedforward control, so that the target specified flow rate is quickly achieved. Thus, Challenge 2 is solved.

In the subsequent cycles (e.g., the second and subsequent cycles of the first torpedo in FIG. 27), the pressure change amount resulting from movement of the torpedo is measured, and the volume change amount is calculated from a result of detecting the position of the torpedo. Using the measured pressure, the “real pressurization volume” is obtained by subtracting the outflow amount, which is calculated by the above Expression 11, from this volume change amount. The corrected bulk modulus is obtained from the pressure change amount and the “real pressurization volume,” and the specified moving speed is calculated by using this corrected bulk modulus. In this way, the flow rate can be set with high accuracy according to the degree of inclusion of air into the molten resin. Thus, Challenge 4 is solved.

Next, advantages of Embodiment 2 will be further described in comparison with Comparative Examples 1 to 3.

### Comparative Example 1

In Comparative Example 1 (Japanese Patent No. 5920859), the flow rate of resin that has been plasticized by a screw is adjusted by a gear pump disposed immediately downstream of the screw.

An advantage of Embodiment 2 over Comparative Example 1 is as follows: In Embodiment 2, instead of adjusting the flow rate of resin that has been plasticized by a screw using a gear pump disposed immediately downstream of the screw, resin having been plasticized by a torpedo is temporarily stored in a plasticization chamber, and the flow rate of this resin, when being discharged, is controlled by the moving speed of the torpedo that is controlled by an actuator. Thus, Embodiment 2 has the advantage of being able to eliminate the need for members of Comparative Example 1 including the gear pump that is provided at a leading end of a nozzle and a piston member that can move back and forth to change the volume of the internal space of the nozzle, and thereby to make the structure simple and compact.

### Comparative Example 2

In Comparative Example 2 (Japanese Patent No. 4166746), to control the outflow amount of molten resin by the pressure and the temperature, change characteristics of a compression rate C (P, T) are obtained with a nozzle closed. An advantage of Embodiment 2 over Comparative Example 2 is as follows. In Embodiment 2, material physical property values needed to calculate the specified value for driving the actuator that controls the moving speed of the torpedo from the specified flow rate (target flow rate) are provided as constants in the data tables of the apparatus. Thus, Embodiment 2 has the advantage of not involving the process of measuring the characteristic values before the injection process.

### Comparative Example 3

In Comparative Example 3 (JP 5-16195 A), the actual injection flow rate value of a molding material injected through a nozzle is calculated based on the assumption that the bulk modulus of the molding material changes according to the position of a plunger.

An advantage of Embodiment 2 over Comparative Example 3 is as follows: Embodiment 2 has the advantage of not involving the process of measuring constants A, B, and C for determining the bulk modulus before the injection process, which is required in Comparative Example 3. This is because, in Embodiment 2, the bulk modulus in the data table is used only for the first cycle (e.g., the first cycle of the first torpedo in FIG. 27), and in the second and subsequent cycles (e.g., the second and subsequent cycles of the first torpedo in FIG. 27), the corrected bulk modulus can be obtained in each cycle while the injection process is performed. Thus, the bulk modulus has a value taking the degree of inclusion of air into account, and an effect equivalent to that of Comparative Example 3 can be produced.

Differences between the feedback control of Comparative Example 3 and that of Embodiment 2 and the reason why in Embodiment 2 the corrected bulk modulus can be obtained while the injection process is performed will be described below in I and II, respectively.

1: In Comparative Example 3, the “actual flow rate” (as termed in Comparative Example 3) is calculated from measurement results of the pressure and the position, and feedback control is performed based on the difference from a target flow rate. On the other hand, the nozzle assumed in Embodiment 2 does not include means for measuring the actual flow rate. In Embodiment 2 (the technical idea of the present disclosure), therefore, the flow rate is controlled by open-loop control also in the second and subsequent cycles. That is, the present disclosure consists in increasing the estimation accuracy of the torpedo moving speed for achieving the specified flow rate (target flow rate) by obtaining the corrected bulk modulus using the measured pressure.

II: The reason why in Embodiment 2 the corrected bulk modulus can be obtained while the injection process is performed is as follows: The volume change due to movement of the torpedo is regarded as the sum of the “real pressurization volume” (the compression volume that contributes to raising the pressure) and a part corresponding to the outflow amount, and this outflow amount is the highly accurate “estimated outflow amount” calculated from the measured pressure by Expression 11. Further, the volume change due to movement of the torpedo has also a highly accurate value based on the actual position measured by the position sensors (potentiometers 16f, 17f). This makes it possible to obtain the “real pressurization volume” that is the difference between the volume change amount and the outflow amount with high accuracy while performing the injection process (=while moving the torpedo and making the resin flow out without closing the nozzle).

In Embodiment 2, the measured pressure, the volume change due to movement of the torpedo, and the “estimated outflow amount” are used to obtain the corrected bulk modulus. As shown in Expression 11, to calculate the “estimated outflow amount,” the measured pressure is used but the bulk modulus is not used. Therefore, the corrected bulk modulus and the bulk modulus can be obtained independently of each other.

In Comparative Example 3, by contrast, the “actual flow rate q°” (as termed in Comparative Example 3) is calculated using a bulk modulus K (z) other than the actual pressure P°. Therefore, even when an attempt is made to obtain the “actual pressurization volume” as termed in Embodiment 2 by subtracting the “actual flow rate q°” from the volume change As·Z° due to movement of the torpedo, and to obtain the corrected bulk modulus from this actual flow rate q° and the actual pressure P°, this calculation does not work because the estimated value (corrected bulk modulus) is used in the calculation process of that estimated value (corrected bulk modulus), which constitutes circular reference in Excel terms.

Further, in Embodiment 2, using values that take into account a change in the viscosity of molten resin relative to the temperature and the flow rate, the target pressure relative to the target specified flow rate that is used for control is calculated by a theoretical formula that determines the flow rate from the viscosity and the pressure (a formula that uses the power law of a non-Newtonian fluid in a pseudoplastic flow and takes into account the dependency of the melt viscosity on the shear velocity and the temperature). Thus, the estimation accuracy can be further enhanced and the specified flow rate (target flow rate) can be quickly achieved. Moreover, exponents n corresponding to various resins are made available in the data table and pseudoplastic viscosities k obtained in advance for respective temperatures are also prepared, which makes it possible to correctly control the flow rates of various resins.

### Embodiment 3

Next, as Embodiment 3, a method of automatically stopping a 3D printer and recording a defect position in the event of creation failure will be described.

The configuration of an injection molding machine 2B of Embodiment 3 is the same as the configuration (see FIG. 14) of the injection molding machine 2A of Embodiment 2, and therefore description thereof will be omitted.

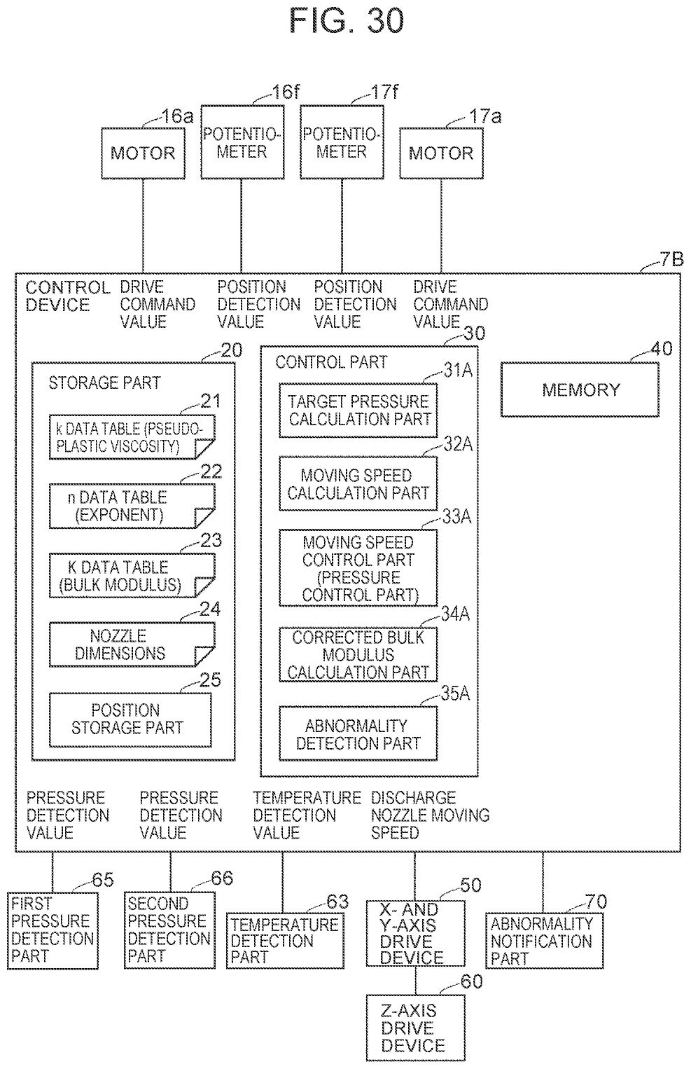

FIG. 30 is a configuration diagram of a control device 7B of Embodiment 3.

The configuration of the control device 7B of Embodiment 3 is the same as the configuration (see FIG. 15) of the control device 7A of Embodiment 2, except that the control device 7B of Embodiment 3 additionally has a position storage part 25, an abnormality detection part 35A, and an abnormality notification part 70 as shown in FIG. 30.

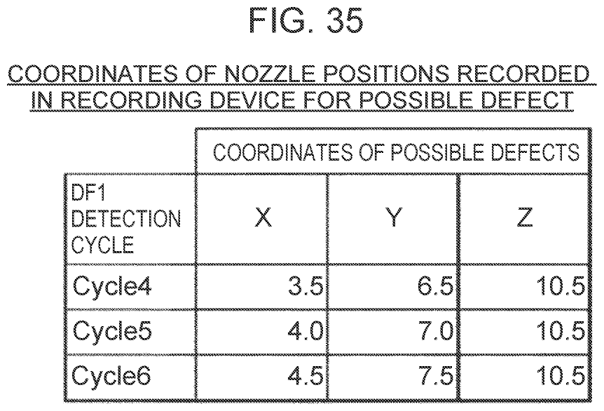

The position storage part 25 is provided, for example, in the storage part 20. The position storage part 25 stores a nozzle position at the point in time when the abnormality detection part 35A has detected an abnormality (defect) (an operation position of the 3D printer that allows location of the position of the nozzle 18a at the point in time when the abnormality (defect) has been detected). FIG. 35 is examples of the positions of the nozzle 18a stored in the position storage part 25.

The abnormality detection part 35A is realized by the control part 30 (processor) executing a predetermined program read from the storage part 20 onto the memory 40 (e.g., the RAM). The abnormality detection part 35A may be realized by hardware. An example of the operation of the abnormality detection part 35A will be described later.

The abnormality notification part 70 is a display that displays an abnormality detected by the abnormality detection part 35A or a speaker that outputs an abnormality detected by the abnormality detection part 35A by voice.

Example of Operation of Abnormality Detection Part 35A

Next, an example of the operation of the abnormality detection part 35A (logic for determining automatic stop and defect occurrence) will be described.

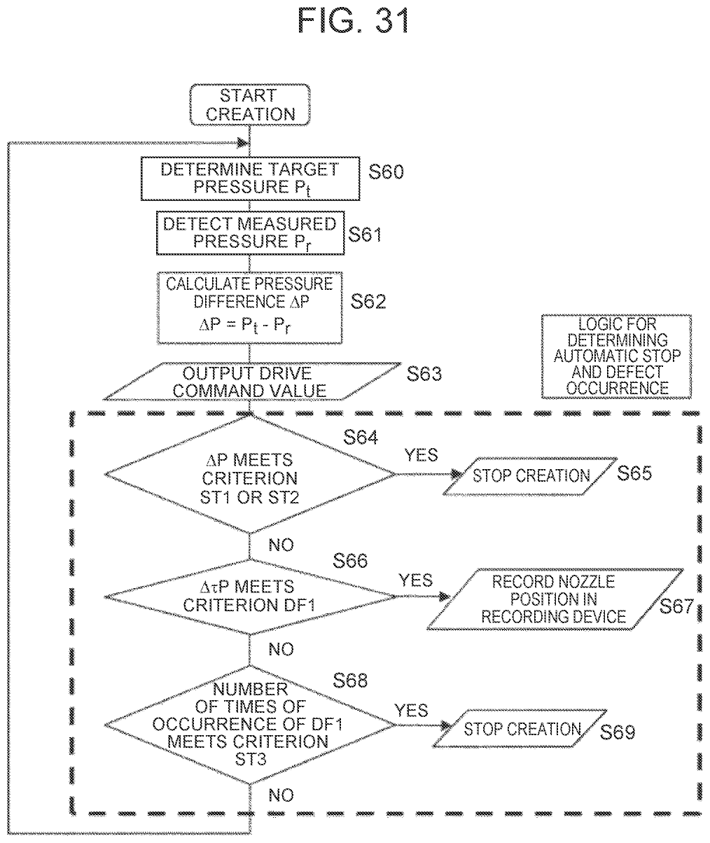

FIG. 31 is a flowchart of an example of the operation of the abnormality detection part 35A (logic for determining automatic stop and defect occurrence). In FIG. 31, the area surrounded by the dashed line is the example of the operation of the abnormality detection part 35A (logic for determining automatic stop and defect occurrence).

First, the target pressure Pₜ is determined (step S60). Specifically, the target pressure Pₜ of the molten resin upstream of the discharge hole is determined so as to achieve a flow rate that is calculated from the moving speed of the discharge nozzle 18a such that resin beads have a constant thickness. The target pressure Pₜ can be determined, for example, by the target pressure calculation part 31A described in Embodiment 2.

Next, the measured pressure Pᵣ is detected (step S61). The measured pressure Pᵣ can be directly detected by a pressure sensor or the like, or be estimated from a value (pressure detection value) of the pressure detection part 65 or 66 (e.g., a strain gauge) mounted on the outer circumferential surface of the first cylinder 11 or the outer circumferential surface of the second cylinder 12.

Next, the pressure difference ΔP is calculated by the following Expression 20 (step S62):

ΔP=Pᵣ−Pₜ (Expression 20)

Here, Pᵣ is the measured pressure and Pₜ is the target pressure.

Next, as in step S47, a drive command value is output to the motor 16a (step S63).

Next, it is determined whether ΔP meets a predetermined criterion ST1 or criterion ST2 (step S64).

The criterion ST1 is, for example, ΔP > threshold value Pmax. The threshold value Pmax is a positive value and a relatively large value that can be determined in advance, for example, by experiment. The criterion ST1 (threshold value Pmax etc.) is stored, for example, in the storage part 20. The criterion ST1 is met when the actual flow rate Q becomes lower than the target flow rate (specified flow rate) due to the discharge nozzle 18a (discharge hole) becoming clogged with unmelted resin fragments or dust or to other causes. This is because when the actual flow rate Q is lower than the target flow rate, the compression amount of resin inside the cylinder 11 becomes larger than expected and the internal pressure rises, so that the measured pressure Pᵣ becomes higher than the target pressure Pₜ.

The criterion ST2 is, for example, ΔP<threshold value Pmin. The threshold value Pmin is a negative value and a relatively small value that can be determined in advance, for example, by experiment. The criterion ST2 (threshold value Pmin etc.) is stored, for example, in the storage part 20. The criterion ST2 is met when the bulk modulus K of the molten resin becomes lower than that without intrusion of air. This is because cases where intrusion of air into the molten resin occurs include a case where the filling rate of the nozzle 18a is low due to an insufficient supply amount of resin pellets resulting from bridging and clogging inside the supply pipe, the influence of the shape of pellets or static electricity, or other causes, and a case where the amount of resin to be plasticized falls below the volume of the first cylinder 11. Resin beads formed in such a state include cavity defects caused by expansion of air having intruded into the resin, which deteriorates the quality of a created object.

When ΔP meets the criterion ST1 (step S64: YES), it is determined that creation failure has occurred due to clogging of the discharge nozzle 18a, and creation is automatically stopped (step S65). Stopping means stopping the discharge nozzle 18a (stopping the actuator (here, the motor 16a or 17a)) and stopping the gantry device 51. In this case (step S64: YES), the abnormality notification part 70 may display information that the discharge nozzle 18a is clogged on the display or output this information by voice.

On the other hand, when ΔP meets the criterion ST2 (step S64: YES), it is determined that creation failure has occurred due to the amount of air included in the molten resin being too large, and creation is automatically stopped (step S65). In this case (step S64: YES), the abnormality notification part 70 may display information that the amount of air included in the molten resin is too large on the display or output this information by voice.

On the other hand, when ΔP meets neither the criterion ST1 nor the criterion ST2 as a result of the determination of step S64 (step S64: NO), it is determined whether ΔP meets a predetermined criterion DF1 (step S66). The criterion DF1 is, for example, ΔP<threshold value P_{DF}. The threshold value P_{DF} is a negative value and larger than the threshold value Pmin. The threshold value P_{DF} can be determined in advance, for example, by experiment. The criterion DF1 (threshold value P_{DF} etc.) is stored, for example, in the storage part 20.

When ΔP meets the criterion DF1 (step S66: YES), it is likely that the amount of air included in the molten resin is rather large (a cavity defect has occurred) (although the additively manufactured article can be adopted as a product). Therefore, to be able to check the area of the cavity defect later, the nozzle position (the operation position of the 3D printer that allows location of the position of the nozzle 18a at the point in time when the abnormality (defect) has been detected) is recorded in the position storage part 25 (step S67). In this case, the abnormality notification part 70 may display information that the amount of air included in the molten resin is rather large (and the nozzle position) on the display or output this information by voice.

On the other hand, when ΔP does not meet the criterion DF1 as a result of the determination of step S66 (step S66: NO), it is determined whether the number of times of occurrence of DF1 meets a criterion ST3 (step S68). The criterion ST3 is: the number of times of occurrence of DF1 (the number of times that ΔP has exceeded the threshold value P_{DF}) > predetermined number of times. The predetermined number of times can be determined in advance as a total cumulative number of times or as a cumulative number of times within a predetermined period. The criterion ST3 (predetermined number of times etc.) is stored, for example, in the storage part 20.

When the number of times of occurrence of DF1 meets the criterion ST3 (step S68: YES), it is determined that creation failure has occurred (a cavity defect has occurred frequently), and creation is automatically stopped (step S69). In this case, the abnormality notification part 70 may display information that a cavity defect has occurred frequently on the display or output this information by voice.

On the other hand, when the number of times of occurrence of DF1 does not meet the criterion ST3 as a result of the determination of step S68 (step S68: NO), the process flow returns to step S60 and the processes of step S60 and the subsequent steps are repeatedly executed.

Another Example of Operation of Abnormality Detection Part 35A

Next, another example of the operation of the abnormality detection part 35A (logic for determining automatic stop and defect occurrence) will be described.

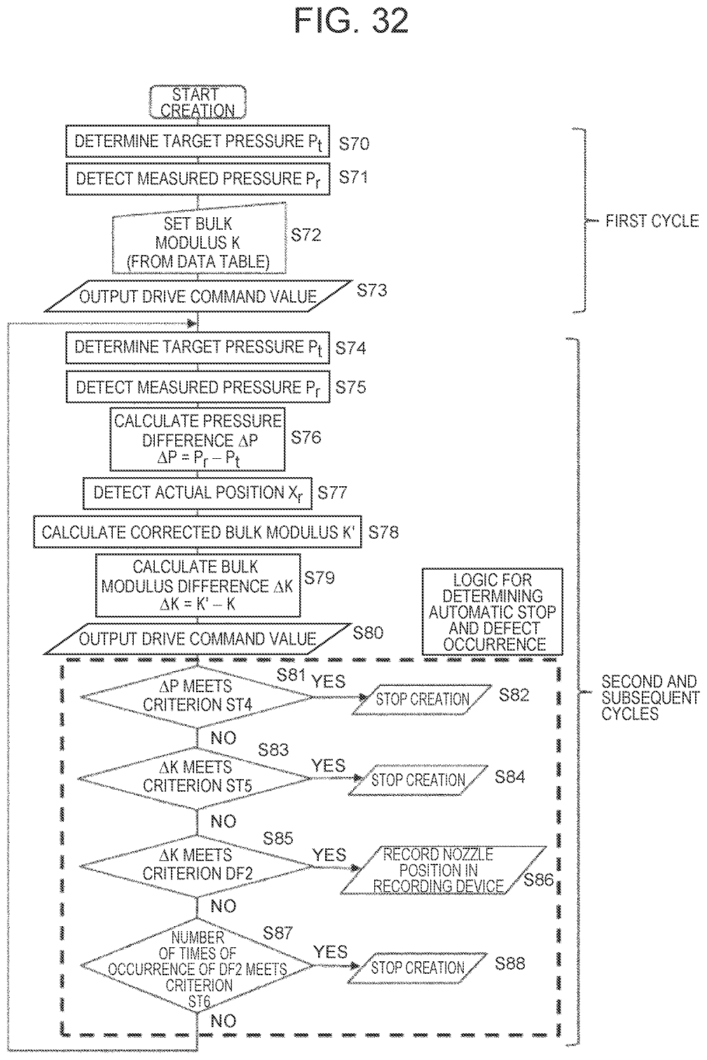

FIG. 32 is a flowchart of another example of the operation of the abnormality detection part 35A (logic for determining automatic stop and defect occurrence). In FIG. 32, the area surrounded by the dashed line is this example of the operation of the abnormality detection part 35A (logic for determining automatic stop and defect occurrence).

FIG. 32 is a flowchart common to an example of the operation of the first torpedo 14 in the first cycle and the second and subsequent cycles, and an example of the operation of the second torpedo 15 in the first cycle and the second and subsequent cycles.

In the following, an example of the operation of the first torpedo in the first cycle (S70 to S73) and an example of the operation thereof in the second and subsequent cycles (S74 to S88) will be described as a representative. An example of the operation of the second torpedo in the first cycle (S70 to S73) and an example of the operation thereof in the second and subsequent cycles (S74 to S88) are the same as the example of the operation of the first torpedo in the first cycle and the example of the operation thereof in the second and subsequent cycles, and therefore description thereof will be omitted.

First, the example of the operation of the first torpedo 14 in the first cycle (S70 to S73) will be described.

First, the target pressure Pₜ is determined (calculated) (step S70).

Next, the measured pressure Pᵣ is detected (step S71).

Next, as in step S45, the bulk modulus K is set (step S72).

Next, as in step S47, a drive command value is output to the motor 16a (step S73).

Next, the example of the operation in the second and subsequent cycles (S74 to S101) will be described.

First, the target pressure Pₜ is determined (calculated) (step S74).

Next, the measured pressure Pᵣ is detected (step S75).

Next, the pressure difference ΔP is calculated by the above Expression 20 (step S76).

Next, the actual position Xᵣ is detected (step S77).

Next, as in step S31, the corrected bulk modulus K′ is calculated by the above Expression 18 (step S78).

Next, a bulk modulus difference ΔK is calculated by the following Expression 21 (step S79):

ΔK=K′−K (Expression 21)

Here, K′ is the corrected bulk modulus and K is the bulk modulus.

Next, as in step S73, a drive command value is output to the motor 16a (step S80).

Next, it is determined whether ΔP meets a predetermined criterion ST4 (step S81). The criterion ST4 is, for example, ΔP > threshold value Pmax. The threshold value Pmax is a positive value and a relatively large value that can be determined in advance, for example, by experiment. The criterion ST4 (threshold value Pmax etc.) is stored, for example, in the storage part 20.

The criterion ST4 is met when the actual flow rate Q becomes lower than the target flow rate (specified flow rate) due to the discharge nozzle 18a (discharge hole) becoming clogged with unmelted resin fragments or dust or to other causes. This is because when the actual flow rate Q is lower than the target flow rate, the compression amount of the resin inside a molten resin storage chamber becomes larger than expected and the internal pressure rises, so that the measured pressure Pᵣ becomes higher than the target pressure Pₜ.

When ΔP meets the criterion ST4 (step S81: YES), it is determined that creation failure has occurred due to clogging of the discharge nozzle 18a, and creation is automatically stopped (step S82). Stopping means stopping the discharge nozzle 18a (stopping the actuator (here, the motor 16a or 17a)) and stopping the gantry device 51. In this case (step S81: YES), the abnormality notification part 70 may display information that the discharge nozzle 18a is clogged on the display or output this information by voice.

On the other hand, when ΔP does not meet the criterion ST4 as a result of the determination of step S81 (step S81: NO), it is determined whether ΔK meets a predetermined criterion ST5 (step S83). The criterion ST5 is, for example, ΔK<threshold value Kmin. The threshold value Kmin is a negative value and a relatively small value that can be determined in advance, for example, by experiment. The criterion ST5 (threshold value Kmin or the like) is stored, for example, in the storage part 20.

When ΔK meets the criterion ST5 (step S83: YES), it is determined that creation failure has occurred due to the amount of air included in the molten resin being too large, and creation is automatically stopped (step S84). In this case (step S83: YES), the abnormality notification part 70 may display information that the amount of air included in the molten resin is too large on the display or output this information by voice.

On the other hand, when ΔK does not meet the criterion ST5 as a result of the determination of step S83 (step S83: NO), it is determined whether ΔK meets a predetermined criterion DF2 (step S85). The criterion DF2 is, for example, AK<threshold value K_{DF}. The threshold value K_{DF} is a negative value and larger than the threshold value Kmin. The threshold value K_{DF} can be determined in advance, for example, by experiment. The criterion DF2 (threshold value K_{DF} etc.) is stored, for example, in the storage part 20.

When ΔK meets the criterion DF2 (step S85: YES), it is likely that the amount of air included in the molten resin is rather large (a cavity defect has occurred) (although the additively manufactured article can be adopted as a product). Therefore, to be able to check the area of the cavity defect later, the nozzle position (the operation position of the 3D printer that allows location of the position of the nozzle 18a at the point in time when the abnormality (defect) has been detected) is recorded in the position storage part 25 (step S86). In this case, the abnormality notification part 70 may display information that the amount of air included in the molten resin is rather large (and the nozzle position) on the display or output this information by voice.

On the other hand, when ΔK does not meet the criterion DF2 as a result of the determination of step S85 (step S85: NO), it is determined whether the number of times of occurrence of DF2 meets a criterion ST6 (step S87). The criterion ST6 is, for example, the number of times of occurrence of DF2 (the number of times that ΔP has exceeded the threshold value K_{DF}) > predetermined number of times. The predetermined number of times can be determined in advance as a total cumulative number of times or as a cumulative number of times within a predetermined period. The criterion ST6 (predetermined number of times etc.) is stored, for example, in the storage part 20.

When the number of times of occurrence of DF2 meets the criterion ST6 (step S87: YES), it is determined that creation failure has occurred (a cavity defect has occurred frequently), and creation is automatically stopped (step S88). In this case, the abnormality notification part 70 may display information that creation failure has occurred (a cavity defect has occurred frequently) on the display or output this information by voice.

On the other hand, when the number of times of occurrence of DF2 does not meet the criterion ST6 as a result of the determination of step S87 (step S87: NO), the process flow returns to step S74 and the processes of step S74 and the subsequent steps are repeatedly executed.

Example of Method of Recording Estimated Position of Creation Defect as Applied to 3D Printer

Next, an example of a method of recording an estimated position of a creation defect as applied to a 3D printer (hereinafter referred to as Example 3) will be described.

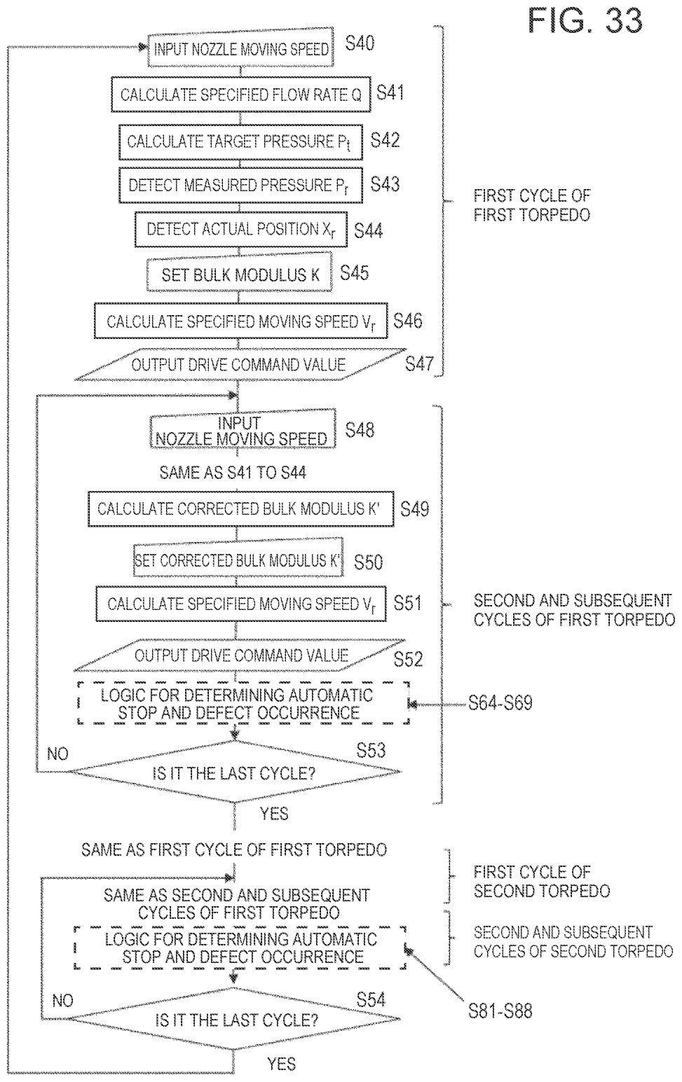

FIG. 33 is a flowchart of the example of the method of recording an estimated position of a creation defect as applied to a 3D printer.

FIG. 33 corresponds to FIG. 27, with the addition of “logic for determining automatic stop and defect occurrence (steps S64 to S69; see the inside of the dashed box in FIG. 31)” and “logic for determining automatic stop and defect occurrence (steps S81 to S88; see the inside of the dashed box in FIG. 32).” As the processes of the steps in FIG. 33 have already been described, description thereof will be omitted.

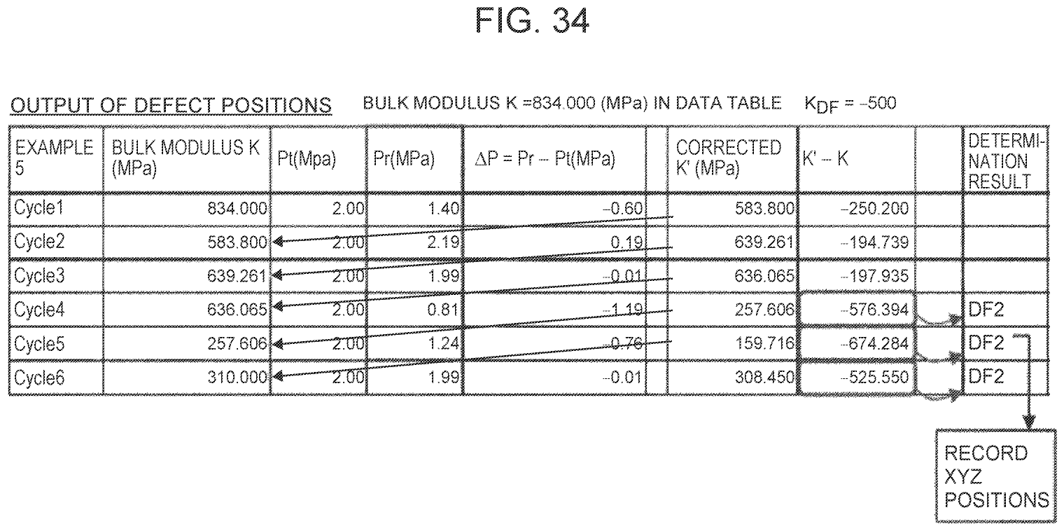

FIG. 34 is a table summarizing results (first to sixth cycles) of Example 3. Specifically, FIG. 34 is a table summarizing results of repeating the processes of steps S40 to S47 of FIG. 33 once and the processes of steps S48 to S52 thereof five times.

FIG. 34 shows that ΔK (=K′−K)<threshold value K_{GF} (=—500), i.e., the criterion DF2, is met in the fourth and the subsequent cycles. In this case, it is likely that the amount of air included in the molten resin is rather large (a cavity defect has occurred). Therefore, to be able to check the area of the cavity defect later, the nozzle position (the operation position of the 3D printer that allows location of the position of the nozzle 18a at the point in time when the abnormality (defect) has been detected) is recorded in the position storage part 25 (step S86). For example, the nozzle position is recorded as shown in FIG. 35. FIG. 35 is examples of estimated positions of creation defects (nozzle positions at the points in time when the abnormality detection part 35A has detected the abnormalities (defects)) stored in the position storage part 25.

Example of Stopping Creation Due to Nozzle Clogging

Next, an example of stopping creation due to nozzle clogging (hereinafter referred to as Example 4) will be described.

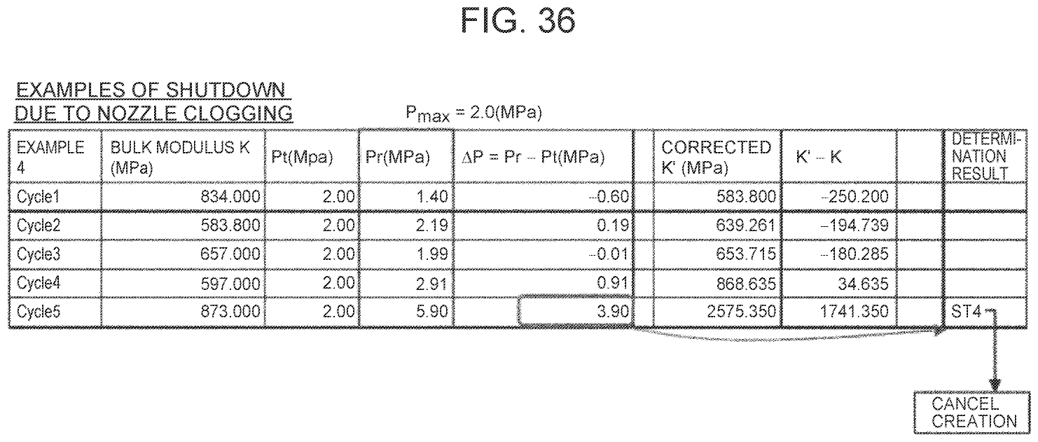

FIG. 36 is a table summarizing results (first to fifth cycles) of Example 4. Specifically, FIG. 36 is a table summarizing results of repeating the processes of steps S40 to S47 of FIG. 33 once and the processes of steps S48 to S52 thereof four times.

FIG. 36 shows that ΔP > threshold value Pmax (=2.0 MPa), i.e., the criterion ST4, is met in the fifth cycle. In this case, it is likely that the pressure rose rapidly as the flow rate decreased due to clogging of the nozzle 18a (discharge hole) with unmelted resin or dust and consequently the compression volume increased. As continuing creation in this state may damage the nozzle 18a, for example, a stop signal ST1 is output to automatically stop creation (step S65).

As has been described above, Embodiment 3 can provide the injection molding machine 2B that can detect occurrence of abnormalities, including the discharge nozzle 18a (discharge hole) becoming clogged with unmelted resin fragments and the discharged resin containing air.

This is made possible by including the abnormality detection part 35A that detects an abnormality based on the target pressure and the measured pressure.

According to Embodiment 3, since abnormalities can be detected as described above, the likelihood of continuously creating additively manufactured articles having many defects and failures without human supervision, such as during automatic operation, can be reduced.

Continuously operating the injection molding machine to discharge resin without noticing the clogged state of the nozzle 18a raises the internal pressure and may damage the cylinders 11, 12 or the actuator (here, the motors 16a, 17a). According to Embodiment 3, when the pressure difference ΔP exceeds the threshold value or the bulk modulus difference exceeds the threshold value, creation is stopped (steps S65, S82, and S84), which can reduce the likelihood of damage to the cylinders 11, 12 or the actuator (here, the motors 16a, 17a).

According to Embodiment 3, the abnormality notification part 70 is included that, when the abnormality detection part 35A detects an abnormality, notifies of the abnormality, so that occurrence of an abnormality can be easily recognized.

According to Embodiment 3, the position storage part 25 is included that, when the abnormality detection part 35A detects an abnormality, stores the coordinate of the discharge nozzle 18a at the point in time when the abnormality has been detected. Thus, by referring to this coordinate, whether the abnormality (defect position) is at an allowable level can be easily determined in an inspection of the additively manufactured object (three-dimensional shaped article) upon completion.

According to Embodiment 3, when the difference (ΔP) between the target pressure and the measured pressure meets the predetermined first criterion (e.g., the criterion ST2: ΔP<threshold value Pmin), the abnormality detection part 35A detects the first abnormality (that the amount of air included in the molten resin is too large), and stops the discharge nozzle 18a (step S65). On the other hand, when the difference (ΔP) between the target pressure and the measured pressure meets the predetermined second criterion (e.g., the criterion DF1: ΔP<threshold value P_{DF}), the abnormality detection part 35A detects the second abnormality (that the amount of air included in the molten resin is rather large (a cavity defect has occurred)), and stores the coordinate of the discharge nozzle 18a at the point in time when the second abnormality has been detected in the position storage part 25 (step S67).

This makes it possible, for example, when the difference (ΔP) is large, to stop the equipment, which would otherwise break down, and when the difference is of a certain magnitude, to continue molding and later inspect the article for defect.

According to Embodiment 3, an abnormality that the abnormality detection part 35A detects when the target pressure is higher than the measured pressure and an abnormality that the abnormality detection part 35A detects when the target pressure is lower than the measured pressure may be different from each other.

Thus, the cause of an abnormality, for example, whether it is intrusion of air or clogging due to resin fragments, can be identified.

Next, modified examples will be described.

In Embodiments 2 and 3, the example has been described in which the injection molding machine of the present disclosure is applied to the injection molding machine 2A including multiple combinations of the cylinder and the torpedo (the cylinder 11 and the first torpedo 14, and the cylinder 12 and the second torpedo 15) However, the present disclosure is not limited thereto. The injection molding machine of the present disclosure may be applied to any injection molding machine that includes a cylinder housing molten resin, a discharge nozzle communicating with the cylinder, and a piston that slides inside the cylinder and pressurizes the molten resin inside the cylinder to discharge the molten resin through the discharge nozzle. Thus, the injection molding machine of the present disclosure may be applied to an injection molding machine (not shown) that includes one combination of the cylinder and the torpedo.

In Embodiments 2 and 3, the example has been described in which the injection molding machine of the present disclosure is applied to an injection molding machine in which a torpedo moves linearly (torpedo injection molding machine). However, the present disclosure is not limited thereto. For example, the injection molding machine of the present disclosure may be applied to an injection molding machine in which a component corresponding to a torpedo rotates (screw injection molding machine).

In Embodiments 2 and 3, the example has been described in which the moving speed control part controls the motor 16a or 17a such that the moving speed of the torpedo meets the specified moving speed Vᵣ calculated and output in step S28 (or step S33). However, the present disclosure is not limited thereto.

For example, the moving speed of the torpedo may be controlled to the specified moving speed Vᵣ calculated and output in step S28 (or step S33) by heating and expanding the molten resin housed (stored) inside the first cylinder 11 and the second cylinder 12, i.e., by controlling the heating temperature of the molten resin housed (stored) inside the first cylinder 11 and the second cylinder 12.

Further, in the case of a screw injection molding machine, for example, the moving speed of the component corresponding to the torpedo may be controlled to the specified moving speed Vᵣ calculated and output in step S28 (or step S33) by controlling the number of rotations of the component corresponding to the torpedo.

In the above embodiments, the present disclosure has been described as a hardware configuration, but the present disclosure is not limited thereto. The present disclosure can also be realized by causing a central processing unit (CPU) to execute a given process in accordance with a computer program.

The program can be stored using various types of non-transitory computer-readable media and supplied to a computer. Non-transitory computer-readable media include various types of tangible storage media. Examples of non-transitory computer-readable media include a magnetic recording medium (e.g., a flexible disc, magnetic tape, and hard disk drive), a magneto-optical recording medium (e.g., a magneto-optical disk), a CD-ROM (read-only memory), a CD-R, a CD-R/W, and a semiconductor memory (e.g., a mask ROM, programmable ROM (PROM), erasable PROM (EPROM), flash ROM, and random-access memory (RAM)). Alternatively, the program may be supplied to a computer by various types of transitory computer-readable media. Examples of transitory computer-readable media include electric signals, optical signals, and electromagnetic waves. Transitory computer-readable media can supply the program to a computer through a wire communication channel, such as a wire or an optical fiber, or a wireless communication channel.

What is claimed is:

1. An injection molding machine comprising:
a cylinder housing molten resin;
a discharge nozzle communicating with the cylinder; and
a piston that slides inside the cylinder and pressurizes the molten resin inside the cylinder to discharge the molten resin through the discharge nozzle,
wherein the injection molding machine comprises:
a target pressure acquisition part that acquires a target pressure which is a target value in pressurizing the molten resin inside the cylinder;
a measured pressure detection part that detects a measured pressure of the molten resin inside the cylinder; and
an abnormality detection part that detects an abnormality based on the target pressure and the measured pressure.

2. The injection molding machine according to claim 1, wherein the abnormality detection part detects the abnormality when a difference between the target pressure and the measured pressure meets a predetermined criterion.

3. The injection molding machine according to claim 2, wherein the abnormality detection part detects the abnormality when the difference exceeds a threshold value.

4. The injection molding machine according to claim 2, wherein the abnormality detection part detects the abnormality when the number of times that the difference has exceeded a threshold value exceeds a predetermined number of times.

5. The injection molding machine according to claim 1, further comprising an abnormality notification part that notifies of the abnormality when the abnormality detection part has detected the abnormality.

6. The injection molding machine according to claim 1, wherein an abnormality that the abnormality detection part detects when the target pressure is higher than the measured pressure and an abnormality that the abnormality detection part detects when the target pressure is lower than the measured pressure are different from each other.

7. An additive manufacturing apparatus comprising the injection molding machine according to claim 1, wherein the additive manufacturing apparatus creates a three-dimensional shaped article by layering the molten resin discharged through the discharge nozzle.

8. The additive manufacturing apparatus according to claim 7, further comprising a position storage part that, when the abnormality detection part has detected the abnormality, stores a coordinate of the discharge nozzle at a point in time when the abnormality has been detected.

9. The additive manufacturing apparatus according to claim 8, wherein:
when a difference between the target pressure and the measured pressure meets a predetermined first criterion, the abnormality detection part detects a first abnormality and stops the discharge nozzle; and
when a difference between the target pressure and the measured pressure meets a predetermined second criterion, the abnormality detection part detects a second abnormality and stores, in the position storage part, a coordinate of the discharge nozzle at a point in time when the second abnormality has been detected.

10. A method of detecting an abnormality in an injection molding machine including:
a cylinder housing molten resin;
a discharge nozzle communicating with the cylinder; and
a piston that slides inside the cylinder and pressurizes the molten resin inside the cylinder to discharge the molten resin through the discharge nozzle,
the method comprising:
a target pressure acquisition step of acquiring a target pressure that is a target value in pressurizing the molten resin inside the cylinder;
a measured pressure detection step of detecting a measured pressure of the molten resin inside the cylinder; and
an abnormality detection step of detecting an abnormality based on the target pressure and the measured pressure.
